(19) United States
(12) Patent Application Publication
(10) Pub. No.: US 2025/0213339 A1
(43) Pub. Date: Jul. 3, 2025

(54) ORAL CARE SYSTEM HAVING MULTI-PORT CONNECTIONS AND MONITORING SYSTEM

(71) Applicant: Sage Products, LLC, Cary, IL (US)

(72) Inventors: David P. Beck, Crystal Lake, IL (US); Stefan Herrmann, Quedlinburg (DE)

(73) Assignee: Sage Products, LLC, Cary, IL (US)

(21) Appl. No.: 18/852,938

(22) PCT Filed: Mar. 31, 2023
(86) PCT No.: PCT/US2023/017036

§ 371 Date: Sep. 30, 2024

Related U.S. Application Data
(60) Provisional application No. 63/326,450, filed on Apr. 1, 2022.

(51) Int. Cl. A61C 17/22; A61C 17/06

(52) U.S. Cl. CPC A61C 17/224; A61C 17/06

(57) ABSTRACT

An injection molded oral care device includes a neck portion and a handle coupled to a first end of the neck portion. where the handle has one or more grips configured to facilitate gripping the oral care device. The oral care device also includes a cleaning head coupled to a second end of the neck portion. The cleaning head includes a base and one or more bristles extending from the base, where the one or more bristles are configured to facilitate cleaning an oral cavity of a patient. The neck portion, handle, and base of the cleaning head are formed by injection molding a first material, and the one or more bristles are formed by injection molding a second material, different from the first material.

### CROSS-REFERENCE TO RELATED PATENT APPLICATION

This application claims the benefit of and priority to U.S. Provisional Application No. 63/326,450, filed on Apr. 1, 2022, the entire disclosure of which is hereby incorporated by reference herein.

### BACKGROUND

The present disclosure relates generally to the field of oral care tools. More specifically, the present disclosure relates to oral care tools that include multiple connections.

Oral care tools are used in clinical settings globally to clean anatomy within an oral cavity of a patient. While standard toothbrush designs may be sufficient in certain clinical settings, in some instances standard toothbrushes are not suitable for certain patients, for example patients that are unable to spit or otherwise remove liquids from their mouths, etc. Suction toothbrushes may be used by healthcare providers to remove fluids from the oral cavities of these patients. However, non-suction and suction toothbrushes throughout the world incorporate different adapters, connectors, and/or components to facilitate use, such that an oral care device in one country may require a different design than in another country.

Specifically, suction toothbrushes may include a connection port or other coupling mechanism, which may be used to fluidly couple a suction toothbrush to a suction hose or a wall suction port. However, around the world, adaptors, connectors, and/or other oral care tools for fluidly coupling a toothbrush and a suction device are not uniform. In this sense, an oral care provider may need various adaptors, connectors, and/or other components in order to use suction toothbrushes in clinical settings in different areas around the world.

Further, in many hospitals or other medical treatment facilities, hygiene procedures like oral care must be repeated multiple times. For example, during treatment a series of oral care products may be used in repetitious fashion, such as periodic cleaning sessions, including evacuation, brushing of the teeth, swabbing of the mouth and gums, etc. However, in the hospital or medical treatment facility setting there is an increased risk of illness (e.g., pneumonia, etc.), especially for those with a compromised immune system. Accordingly, compliance with a proper oral care regime, which includes repetitious brushing over predetermined intervals, is important.

Accordingly, it would be advantageous to provide oral care tools that may be adapted to be used in various clinical settings throughout the world, as well as to increase the ease of manufacture for the different adaptations of the tools. In addition, it would be advantageous to provide oral care tools that supplement proper oral care regimes in hospitals, medical facilities, and/or at home.

### BRIEF DESCRIPTION OF THE FIGURES

FIG. 1 is a bottom perspective view of an oral care device, according to an embodiment.

FIG. 2 is a top perspective view of the oral care device of FIG. 1, according to an embodiment.

FIG. 3 is a bottom perspective view of a first variation of the oral care device of FIGS. 1-2, according to an embodiment.

FIG. 4 is a top perspective view of the oral care device of FIG. 3, according to an embodiment.

FIG. 5 is a bottom perspective view of a second variation of the oral care device of FIGS. 1-4, according to an embodiment.

FIG. 6 is a top perspective view of the oral care device of FIG. 5, according to an embodiment.

FIG. 7 is an end perspective view of a cleaning head of the oral care device of FIGS. 1-6, according to an embodiment.

FIG. 8 is an alternate side view of the cleaning head of FIG. 7, according to an embodiment.

FIG. 9 is a side view of an oral care coupling, according to an embodiment.

FIG. 10 is an exploded view of the oral care coupling of FIG. 9, according to an embodiment.

FIG. 11 is a side view of a first portion of the oral care coupling of FIG. 9, according to an embodiment.

FIG. 12 is a side view of a second portion of the oral care coupling of FIG. 9, according to an embodiment.

FIG. 13 is a top view of an oral care device, according to an exemplary embodiment.

FIG. 14 is a top view of a cleaning head of the oral care device of FIG. 13, according to some embodiments.

FIG. 15 is a top view of a suction mount of the oral care device of FIG. 13, according to some embodiments.

FIG. 16 is a top view of the oral care device of FIG. 13, according to some embodiments.

FIG. 17 is a block diagram of an oral care services system which can be used with the oral care device of FIGS. 13-16, the oral care device of FIGS. 1-8, and/or the oral care coupling of FIGS. 9-12, according to some embodiments.

FIG. 18 is a block diagram of an oral care manager platform which can be used with the oral care services system of FIG. 17, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, oral care systems and devices that are formed via injection molding are shown, according to exemplary embodiments. The oral care devices described herein may be formed using a single mold or cast, and in some instances a mold insert and/or overmold insert. The single mold and/or inserts may be used to form different oral care devices, such that the injection molding process described herein decreases cost, increases efficiency, and/or otherwise eases certain processes of providing (e.g., manufacturing) various oral care devices. In this regard, the single mold (and/or inserts) may be used to provide injection molded oral care devices that are configured for use in combination with different components (e.g., adaptors, connectors, etc.) in different clinical settings throughout the world.

Referring to the figures generally still, an oral care device associated with an oral care manager platform for controlling and/or monitoring use of the oral care device using suction and non-suction operation is shown, according to various embodiments. An oral care manager platform is a component of an oral care services system that obtains oral care data from the oral care device and/or one or more external devices (e.g., a user device, a storage system, a healthcare provider device, a service provider device, a component supplier device, etc.). The oral care manager platform may obtain oral care data, generate a device use profile that includes information relating to use of the oral care device, and transmit the device use profile to an external device, for example to monitor and/or control use of the oral care device in order to ensure safe, regular, and/or effective use.

### Injection Molded Oral Care Device

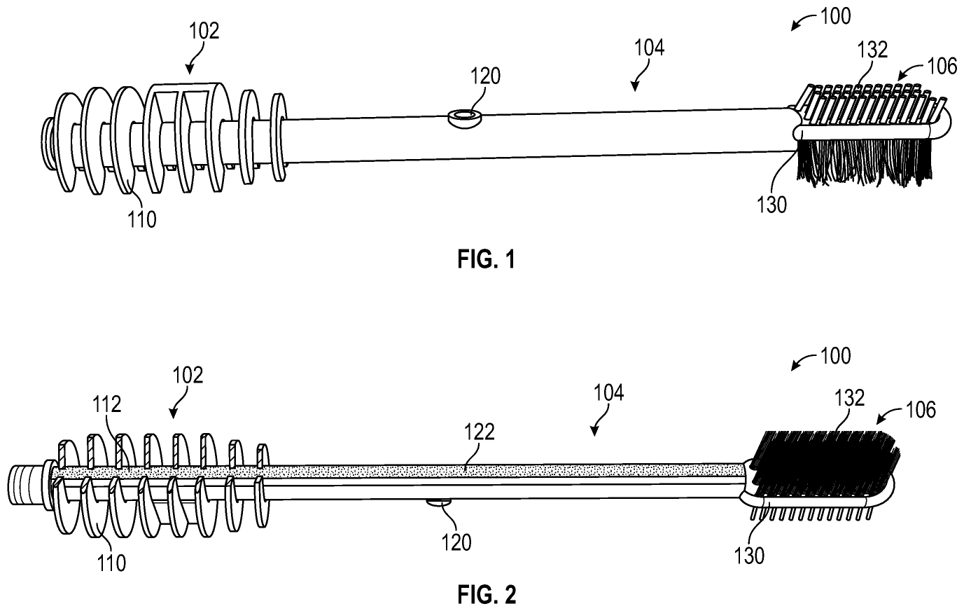

In an exemplary embodiment, shown in FIGS. 1-8, an oral care system includes an injection molded oral care device, the oral care device comprising a base, a handle coupled to a first end of the base, and a cleaning head coupled to a second end of the base. The handle may include one or more grips configured to facilitate gripping the oral care device, and the cleaning head may include a base and one or more bristles extending from the base configured to facilitate cleaning the oral cavity of the patient. In some embodiments, the oral care device also includes a lumen extending from the handle to the cleaning head, and the lumen is configured to suction fluid from the cleaning head to the handle, for example to move fluid away from an oral cavity. In other embodiments, the oral care device includes a connection port coupled to the handle, the connection port configured to fluidly couple the oral care device to the suction device. In some embodiments, the connection port includes a connection interface comprising concentric rings spaced along the connection port, the connection interface being configured to engage (e.g., couple) a flexible plastic (e.g., tube, etc.) of the suction device. In other embodiments, the connection port includes a plug interface formed of a flexible plastic, the plug interface being configured to engage (e.g., couple) a rigid plastic (e.g., rigid connector) of the suction device. According to an exemplary embodiment, the oral care device includes a channel extending from the handle to the cleaning head, the channel configured to receive a flexible plastic and facilitate forming the one or more bristles of the cleaning head, the plug interface, and/or other components of the oral care device.

Referring now to FIGS. 1-6, side views of an oral care device 100 are shown, according to an exemplary embodiment. The oral care device 100 is shown to include a handle 102, a neck portion 104, and a cleaning head 106. The handle 102 may be coupled to a first end of the neck portion 104, and may be configured to enable a user (e.g., a patient, healthcare provider, etc.) to grasp the oral care device 100. In an exemplary embodiment, the neck portion 104 is coupled to the handle 102 at the first end and the cleaning head 106 at a second end (e.g., extend between the handle 102 and the cleaning head 106). The cleaning head 106 may be configured to fit within an oral cavity (e.g., of a patient), so as to facilitate cleaning the anatomy of the oral cavity. In some embodiments, the handle 102 is fluidly coupled to the neck portion 104 (e.g., via a first lumen, a second lumen, etc.), and/or the neck portion 104 is fluidly coupled to the cleaning head 106, as discussed below. The handle 102 may further be coupled (e.g., at a second end opposite the neck portion 104 and cleaning head 106) to one or more fluid flow devices (e.g., suction device, fluid vacuum, a reservoir, etc.) to enable routing of fluid through the oral care device 100. As will be discussed in greater detail below, the handle 102 may be coupled to a suction device, so as to enable routing of fluid from the oral cavity, through the oral care device 100, and away from the oral cavity (e.g., to the suction device). In other embodiments, the handle 102 is coupled to a fluid reservoir, so as to enable routing of fluid (e.g., cleaning solution, etc.) from a fluid reservoir, through the oral care device 100, and to the oral cavity.

As shown in FIGS. 1-6, the handle 102 includes one or more grips 110 and a handle channel 112 running longitudinally along the handle 102. According to an exemplary embodiment, the handle 102 (e.g., the grips 110, the handle channel 112, etc.) is formed of polypropylene or another rigid plastic. In an exemplary embodiment, the grips 110 include one or more radially extending ribs and the grips 110 are configured to facilitate gripping or handling of the oral care device 100 (e.g. by a patient, healthcare provider, etc.). The grips 110 (e.g., ribs) may be of varying radii, and may be configured to mimic a hand shape and/or conform to a hand (e.g., of a patient, healthcare provider, etc.). The handle channel 112 may extend along the handle 102 (e.g., from the first end to the second end), and may be configured to receive a low durometer plastic (e.g., polyolefin) and/or other suitable flexible material, as discussed below. In an exemplary embodiment, the handle channel 112 extends along an exterior top portion of the handle 102. It should be understood that while the handle 102 is described herein as being formed of polypropylene and having certain components and/or configurations, it is contemplated that the handle 102 may be formed of other suitable material, the grips 110 may include other gripping features, and/or the handle channel 112 may extend along another portion of the handle 102 (e.g., exterior middle, bottom, side, etc. portion, interior top, middle, bottom, side, etc.).

As shown in FIGS. 1-6, the neck portion 104 extends between the handle 102 and the cleaning head 106, and includes a neck port 120 and a base channel 122 running longitudinally along the neck portion 104 (the base channel 122 being an extension of the handle channel 112). According to an exemplary embodiment, the neck portion 104 (e.g., the neck port 120, the base channel 122, etc.) is formed of polypropylene or another rigid plastic, and/or is integrally coupled with the handle 102 at a first end and the cleaning head 106 at a second end. In an exemplary embodiment, the neck port 120 is positioned at a middle and bottom portion of the neck portion 104, and is configured to provide an opening (e.g., channel, hole, etc.) into an interior of the neck portion 104. The base channel 122 may extend along the neck portion 104 (e.g., from the first end to the second end), and may be configured to receive a low durometer plastic (e.g., polyolefin) and/or other suitable flexible material, as discussed below. In an exemplary embodiment, the base channel 122 extends along an exterior top portion of the neck portion 104, and is in communication (e.g., connected, integrated, etc.) with the handle channel 112 of the handle 102. It should be understood that while the neck portion 104 is described herein as being formed of polypropylene and having certain components and/or configurations, it is contemplated that the neck portion 104 may be formed of other suitable material, the neck port 120 may be at another portion of the neck portion 104 and/or in communication with another component of the oral care device 100, and/or the base channel 122 may extend along another portion of the neck portion 104.

As shown in FIGS. 1-6, the cleaning head 106 includes a base 130 and one or more cleaning elements. According to an exemplary embodiment, the cleaning head 106 (e.g., the base 130) is formed of polypropylene or another rigid plastic, and/or is integrally coupled with the neck portion 104. In an exemplary embodiment, the base 130 extends longitudinally from the neck portion 104 in a direction substantially parallel to the neck portion 104, and includes a channel (not shown) configured to receive a low durometer plastic (e.g., polyolefin) and/or other suitable flexible material. The cleaning elements, shown as bristles 132, extend from one or more surfaces of the base 130, and may be configured to facilitate cleaning and/or debridement of surfaces within the oral cavity (e.g., plaque removal, etc.). According to an exemplary embodiment, the bristles 132 are coupled with the low durometer plastic (e.g., polyolefin) and/or other suitable flexible material extending within the base channel 122 (e.g., via the channel of the cleaning head 106), and are affixed to one or more exterior surfaces of the base 130. In other embodiments, the bristles 132 are coupled with the low durometer plastic (e.g., polyolefin) and/or other suitable flexible material extending within the base channel 122 (e.g., via the channel of the cleaning head 106), and are fixed to an interior region of the base 130 and protrude through one or more apertures in the base 130 to an exterior region of the base 130. It should be understood that while the base 130 of cleaning head 106 is described herein as being formed of polypropylene and having certain components and/or configurations, it is contemplated that the cleaning head 106 may be formed of another suitable material, the base 130 may be otherwise oriented (e.g., angled, curved, etc.), and/or the bristles 132 may be otherwise oriented and/or include other cleaning elements (e.g., extend radially around, from a bottom, side, etc., surface of the base 130, include a pad, foam, etc.).

Referring now to FIGS. 1-2, the oral care device 100 is shown to include the neck portion 104 coupled between the handle 102 and the cleaning head 106. According to an exemplary embodiment, the handle 102, neck portion 104, and cleaning head 106 are integrally formed, and components thereof (e.g., grips 110, neck port 120, base 130) are formed of polypropylene or another rigid plastic. In an exemplary embodiment, the base channel 122 is in communication with the handle channel 112 and the channel of the cleaning head 106. The handle channel 112, base channel 122, and channel of the cleaning head 106 may be configured to receive a low durometer plastic (e.g., polyolefin) and/or other suitable flexible material, and/or may be used to form the cleaning elements of the cleaning head 106 (e.g., the bristles 132).

In the exemplary embodiment of FIGS. 1-2, the oral care device 100 is used for non-suction oral care (in view of its lacking any standard port connection). Accordingly, the handle 102, the neck portion 104, and the cleaning head 106 are solid. In other embodiments, however, the handle 102, the neck portion 104, and/or the cleaning head 106 may be hollow (e.g., include a first lumen, a second lumen, etc.), such that the oral care device 100 of FIGS. 1-2 may be used to provide suction oral care.

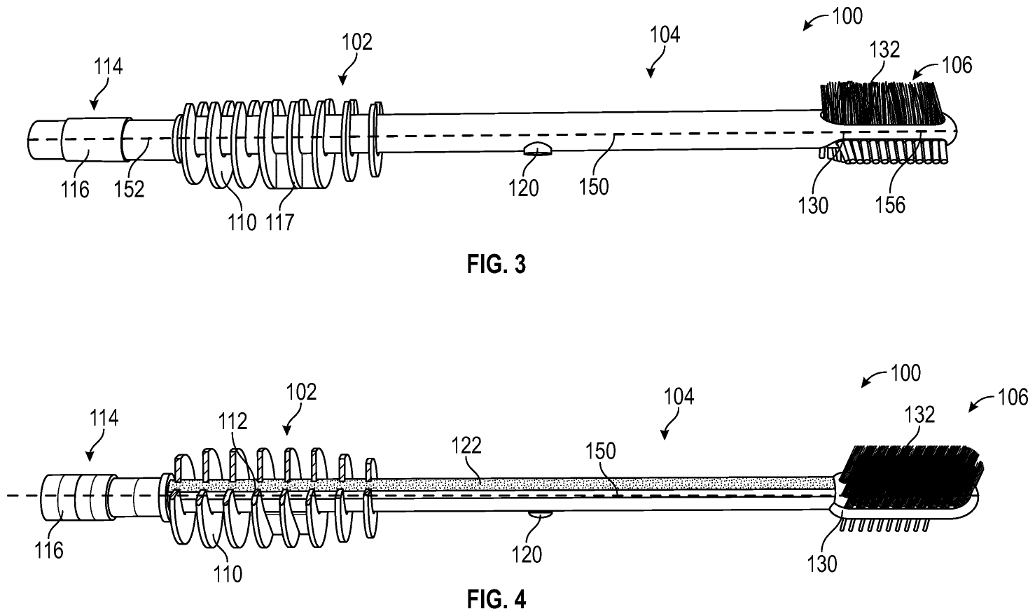

Referring now to FIGS. 3-6, two variations of the oral care device 100 of FIGS. 1-2 are shown, according to other exemplary embodiments. In FIGS. 3-6, the oral care device 100 further includes a connection port 114 and a first lumen 150 (depicted with a dotted line). According to an exemplary embodiment, the connection port 114 extends from an end of the handle 102 (e.g., a second end opposite the neck portion 104 and the cleaning head 106), and is configured to couple one or more fluid flow devices (e.g., suction device, fluid vacuum, a reservoir, etc.). The connection port 114 may include one or more connection interfaces (e.g., plug interface, socket interface, etc.), which may be configured to ensure adequate coupling between various fluid flow devices and/or systems, as discussed below.

As shown in FIGS. 3-6, the first lumen 150 is positioned within components of the oral care device 100, and extends from the handle 102, through the neck portion 104, and to the cleaning head 106. According to an exemplary embodiment, the handle 102 (e.g., connection port 114) includes a portion of the first lumen 150, which enables fluid coupling of the handle 102 to one or more fluid flow devices (e.g., suction device, fluid vacuum, a reservoir, etc.). According to an exemplary embodiment, the first lumen 150 is configured to enable routing of fluid through the oral care device 100 when the oral care device 100 is coupled to one or more fluid flow devices. In other embodiments, the oral care device 100 includes the first lumen 150, and one or more additional lumens (e.g., a second lumen, a third lumen, etc.), which may be fluidly coupled to a fluid flow device and/or enable routing of fluid through the oral care device 100. For example, the oral care device 100 may include the first lumen fluidly coupled to a suction device, which enables suction of fluid from the oral cavity to the suction device, and a second lumen fluidly coupled to a fluid reservoir (e.g., having a cleaning solution), which enables delivery of a cleaning solution to the oral cavity.

In some embodiments, the handle 102 includes a handle port 117. The handle port 117 may be a port (e.g., thumb port, etc.) positioned on a lower portion of the handle 102, and may be fluidly coupled to the first lumen 150. According to an exemplary embodiment, the handle port 117 is configured to enable movement (e.g., suction, etc.) of fluid through the oral care device 100. For example, the handle 102 (e.g., the connection port 114) may be fluidly coupled to one or more fluid flow devices (e.g., suction device, fluid vacuum, a reservoir, etc.), such that the first lumen is in fluid communication with the fluid processing device. The handle port 117 is configured for a user's thumb to cover the port such that the closed handle port 117 facilitates suction of fluid through the oral care device 100. In other embodiments, the handle port 117 may be coupled to a closed suction system (e.g., swivel elbow closed suction system, a plug, etc.), for closing the handle port 117 to facilitate suction of fluid through the oral care device 100. In some embodiments, the handle port 117 is positioned at other portions of the handle 102 (e.g., side, top, etc.) and/or the oral care device 100 (e.g., a rear, middle, front, etc. portion of the neck portion 104, etc.).

Referring specifically to FIGS. 3-4, the oral care device 100 is shown to include the neck portion 104 coupled between the handle 102 and the cleaning head 106, and the connection port 114 in the form of a socket port connection 116. According to an exemplary embodiment, the handle 102, neck portion 104, cleaning head 106, connection port 114, and components thereof (e.g., grips 110, neck port 120, base 130) are integrally formed and are formed of polypropylene or another rigid plastic. The connection port 114 may include a connection interface configured to ensure adequate coupling between the handle 102 and one or more fluid flow devices and/or systems. According to the exemplary embodiment of FIGS. 3-4, the connection port 114 is a socket port connection 116, and is configured to engage a flexible plastic (e.g., low durometer plastic) for coupling the handle 102 to a fluid flow device and/or component thereof. For example, the socket port connection 116 may include a connection interface that includes a concentric ridge, concentric ridges spaced along the socket port connection 116, elevated ridges forming a stair-step interface, and/or any other suitable interface, which may engage a flexible plastic (e.g., tube, etc.) of a fluid flow device.

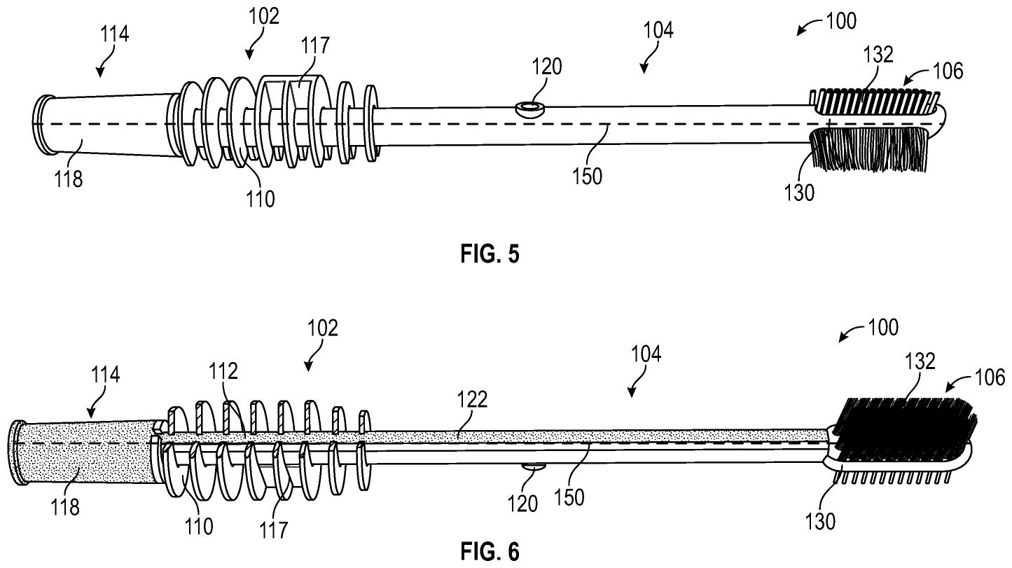

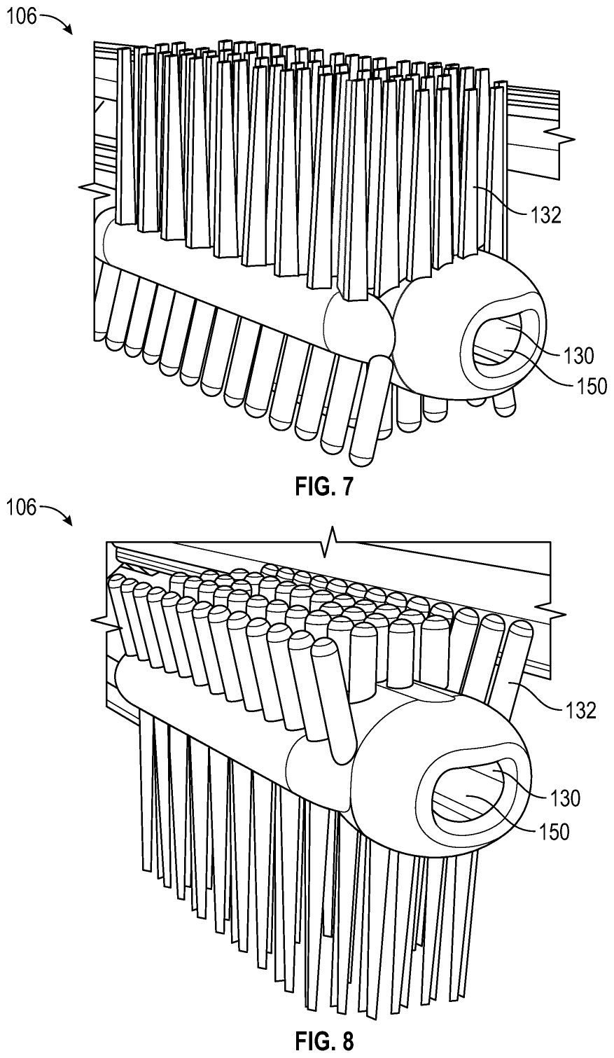

Referring specifically to FIGS. 5-6, the oral care device 100 is shown to include the neck portion 104 coupled between the handle 102 and the cleaning head 106, and the connection port 114 in the form of a plug interface 118. According to an exemplary embodiment, the handle 102, neck portion 104, cleaning head 106, and components thereof (e.g., grips 110, neck port 120, base 130) are integrally formed and are formed of polypropylene or another rigid plastic. The plug interface 118 may be formed of a low durometer plastic (e.g., polyolefin) and/or other suitable flexible material, and may be configured to ensure adequate coupling between the handle 102 and one or more fluid flow devices and/or systems. According to the exemplary embodiment of FIGS. 5-6, the plug interface 118 is configured to engage a rigid plastic for coupling the handle 102 to a fluid flow device and/or component thereof.

Referring now to FIGS. 7-8, side views of a cleaning head 106 are shown, according to an exemplary embodiment. As discussed above, the cleaning head 106 includes the base 130 and one or more cleaning elements, shown as bristles 132. The base 130 may extend longitudinally from the neck portion 104, and the bristles 132 may be affixed to one or more exterior surfaces of the base 130. As shown in FIGS. 7-8, the bristles 132 are affixed to two exterior surfaces of the base 130 (e.g. a top surface and a bottom surface), and are integrally coupled at the exterior of the base 130. The bristles 132 may be formed of a flexible material (e.g., polyolefin, low durometer plastic, etc.), which may be affixed to the exterior of the base 130 (as shown in FIGS. 7-8). In some embodiments (not shown), the bristles 132 are fixed to an interior region of the base 130 and protrude through one or more apertures in the base 130 to an exterior region of the base 130. In other embodiments, the cleaning elements include additional, fewer, and/or different components, for example one or more bristle sections, one or more foam or plastic sections, etc.

According to an exemplary embodiment, the cleaning head 106 further includes a portion of the first lumen. The first lumen extends longitudinally within the base 130, and provides an outlet at an end of the cleaning head 106. In some embodiments, the first lumen provides an outlet at another portion of the cleaning head 106 (e.g., a top surface, a bottom surface, a side surface, etc.), and/or is in communication with one or more ports positioned at the cleaning head 106 (e.g., a top surface, bottom surface, side surface, etc.). In this regard, in some embodiments the cleaning head 106 (e.g., the oral care device 100) is configured to enable routing of fluid to/from an oral cavity, so as to allow oral care treatments that use suction.

According to an exemplary embodiment, the oral care device 100 described herein is formed using an injection molding process. The oral care device 100 may be molded by filling a mold cavity with one or more materials, which when allowed to cure or cool may be shaped into the oral care device 100. In an exemplary embodiment, the mold cavity includes cavities and/or projections shaped as the inverse (e.g., opposite, counterpart, etc.) of components of the oral care device 100. The mold cavity may also receive one or more inserts, which may be used to fill (or prevent filling) one or more portions of the mold cavity, as discussed below. According to an exemplary embodiment, the mold cavity includes a runner that permits the oral care device 100 to be formed via a plurality of steps (e.g., a two-part process, an overmold process, etc.), however, in other embodiments the mold cavity includes fewer, additional, and/or different working components that permit the oral care device 100 to be formed in a single step. Further, the mold may incorporate one or more mold design factors, such as runner and gate size, gate placement, venting and molding parameters, mold material or materials, etc. that affect the molded part (e.g., the oral care device 100). As discussed above, components of the oral care device 100 may be formed of polypropylene or another rigid plastic (e.g., polystyrene, acrylonitrile butadiene styrene, high-density polyethylene, polyether ether ketone, polyamide, polycarbonate, polyetherimide, polybutylene terephthalate, acrylic, polyoxymethylene, polypropylene, silicone, thermoplastic elastomers, thermoplastic polyurethane, thermoplastic rubber, etc.), polyolefin or another low durometer plastic, and/or any other suitable material. It should be understood that while the injection molding process described herein is described as using a single mold having a single mold cavity, any number of suitable molds (e.g., two, three, etc.), mold cavities (e.g., two, three, five, ten, etc.), inserts, and/or other components may be used to form the oral care device 100.

According to an exemplary embodiment, the oral care device 100 of FIGS. 1-2 is formed via an injection molding process. In an exemplary embodiment, the oral care device 100 of FIGS. 1-2 is formed by filling a mold cavity with a mold insert at a first end of the mold cavity (e.g., a mold insert of the socket port connection 116). The mold insert may be configured to fill a portion of the mold cavity to prevent or block shaping of that component of the oral care device 100. The mold cavity may also include a runner extending from a first end of the mold cavity to a second end of the mold cavity, which may allow for overmolding as discussed below. According to an exemplary embodiment, the mold cavity (e.g., having the mold insert) is filled with polypropylene or another rigid plastic, which when allowed to cure or cool is shaped into components of the oral care device 100 of FIGS. 1-2 (e.g., the handle 102, the neck portion 104, the base 130, etc.). For example, upon curing or cooling, the runner of the mold cavity may form channels along components of the oral care device 100 (e.g., the handle channel 112, the base channel 122, a channel of the cleaning head 106, etc.), and/or the mold insert prevents formation of the socket port connection 116.

In an exemplary embodiment, after the polypropylene or other plastic is allowed to cure or cool, the mold cavity is filled with an overmold insert at the first end of the mold cavity (so as to prevent or block formation of plug interface 118). Similar to the mold insert discussed above, the overmold insert may be configured to fill a portion of the mold cavity and/or prevent overmolding of a component of the oral care device 100 of FIGS. 1-2. In some embodiments, the overmold insert and the mold insert are a single component. According to an exemplary embodiment, the mold cavity (e.g., having the overmold insert) is filled with polyolefin or another low durometer plastic. The polyolefin or other low durometer plastic may fill vacant spaces in the mold cavity (e.g., formed by the runner, inverse cavities to the bristles 132, etc.), and upon curing or cooling the polyolefin or other plastic may form components of the oral care device 100 of FIGS. 1-2. For example, the polyolefin or other plastic may fill one or more channels of the oral care device 100 (e.g., the handle channel 112, the base channel 122, a channel in the cleaning head 106, etc.) and/or form the bristles 132 of the cleaning head 106 upon curing or cooling. Upon curing or cooling, the material formed as the oral care device 100 of FIGS. 1-2 may be ejected from the mold cavity.

According to an exemplary embodiment, the oral care device 100 of FIGS. 3-4 is also formed via an injection molding process. In an exemplary embodiment, the oral care device 100 of FIGS. 3-4 is formed by filling the mold cavity (discussed above) with polypropylene or another rigid plastic. The mold cavity may include the runner extending from the first end of the mold cavity to the second end of the mold cavity. However, in an exemplary embodiment the mold cavity does not include the mold insert (e.g., as discussed above) such that socket port connection 116 is formed for the oral care device 100. In some embodiments, the mold insert is removed from the mold cavity, for example after using the mold to form the oral care device 100 of FIGS. 1-2, as discussed above. According to an exemplary embodiment, the polypropylene or other rigid plastic is allowed to cure or cool, and the plastic is shaped into components of the oral care device 100 of FIGS. 3-4. For example, upon curing or cooling the runner of the mold cavity may form channels along components of the oral care device 100 (e.g., the handle channel 112, the base channel 122, a channel of the cleaning head 106, etc.) and/or the mold cavity may be configured to form the oral care device 100 having socket port connection 116.

In an exemplary embodiment, after the polypropylene or other plastic is allowed to cure or cool, the mold cavity is filled with the overmold insert at the first end of the mold cavity. The overmold insert may be configured to fill a portion of the mold cavity and/or prevent overmolding of a component of the oral care device 100 of FIGS. 3-4 (e.g., plug interface 118). According to an exemplary embodiment, the mold cavity (e.g., having the overmold insert) is filled with polyolefin or another low durometer plastic. The polyolefin or other low durometer plastic may fill vacant spaces in the mold cavity (e.g., formed by the runner, inverse cavities to the bristles 132, etc.), and upon curing or cooling the polyolefin or other plastic may form components of the oral care device 100 of FIGS. 3-4. For example, the polyolefin or other plastic may fill one or more channels of the oral care device 100 (e.g., the handle channel 112, the base channel 122, etc.) and/or form the bristles 132 of the cleaning head 106 upon curing or cooling. Upon curing or cooling, the material formed as the oral care device 100 of FIGS. 3-4 may be ejected from the mold cavity.

According to an exemplary embodiment, the oral care device 100 of FIGS. 5-6 is also formed via an injection molding process. In an exemplary embodiment, the oral care device 100 of FIGS. 5-6 is formed by filling the mold cavity (discussed above) with polypropylene or another rigid plastic, just as described above with respect to the embodiment of FIGS. 1-2. According to an exemplary embodiment, the polypropylene or other rigid plastic is allowed to cure or cool, and the plastic is shaped into components of the oral care device 100 of FIGS. 5-6.

In an exemplary embodiment, after the polypropylene or other plastic is allowed to cure or cool, the mold cavity is filled with polyolefin or another low durometer plastic. According to an exemplary embodiment, the mold cavity does not include the overmold insert (discussed above). In some embodiments, the overmold insert is removed from the mold cavity, for example after using the mold to form the oral care device 100 of FIGS. 1-2, as discussed above. The polyolefin or other low durometer plastic may fill vacant spaces in the mold cavity (e.g., formed by the runner, inverse cavities to the bristles 132, etc.), and upon curing or cooling the polyolefin or other plastic may form components of the oral care device 100 of FIGS. 5-6. For example, upon curing or cooling the polyolefin or other plastic may fill one or more channels of the oral care device 100 (e.g., the handle channel 112, the base channel 122, etc.). According to an exemplary embodiment, upon curing or cooling the polyolefin or other plastic form the plug interface 118 of the connection port 114 and/or the bristles 132 of the cleaning head 106. Upon curing or cooling, the material formed as the oral care device 100 of FIGS. 5-6 may be ejected from the mold cavity.

### Universal Oral Care Coupling

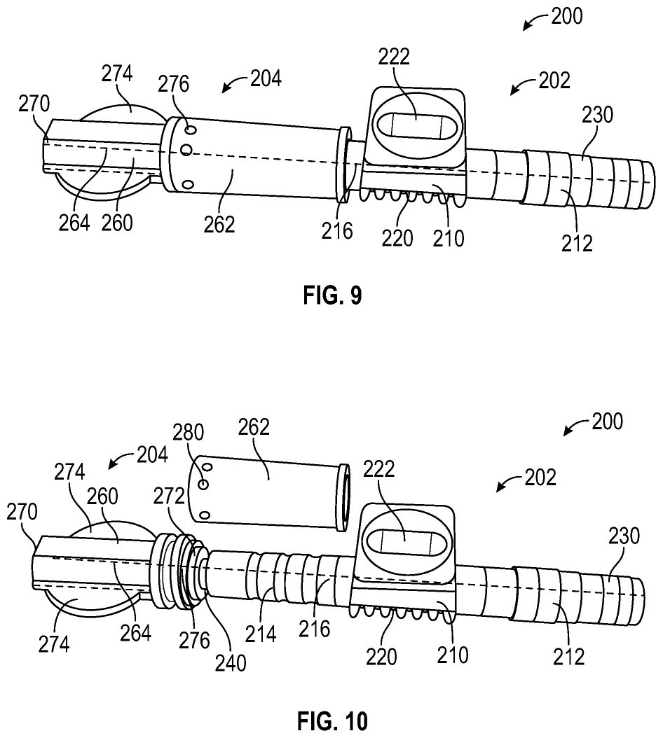

Referring to FIGS. 9-12, a universal oral care coupling (hereinafter “oral care coupling 200”) is shown, according to an exemplary embodiment. The oral care coupling 200 described herein may include components arranged in various configurations, such that components of the coupling may fluidly couple an oral care device to one or more fluid flow devices (e.g., suction device). The oral care coupling 200 is shown to include a first portion 202 and a second portion 204. The first portion 202 and the second portion 204 may be configured to selectively de-couple, thereby providing a first configuration and a second configuration for fluid coupling between an oral care device and one or more fluid flow devices. For example, the first portion 202 and the second portion 204 may be formed as a unitary component, and in this first configuration, configured to fluidly couple an oral care device (e.g., at the second portion 204) and a component (e.g., a flexible tube) of a first fluid flow device (e.g., at the first portion 202). Further, the first portion 202 and the second portion 204 may be de-coupled, and in this second configuration, the second portion 204 may be configured to fluidly couple an oral care device and a component (e.g., a rigid connector) of a second fluid flow device. As will be discussed in greater detail below, components of the oral care coupling 200 may be configured to de-couple, so as to provide a universal oral care tool that offers fluid coupling between an oral care device and various fluid flow devices (e.g., having different adapters, connectors, components, etc.) throughout the world.

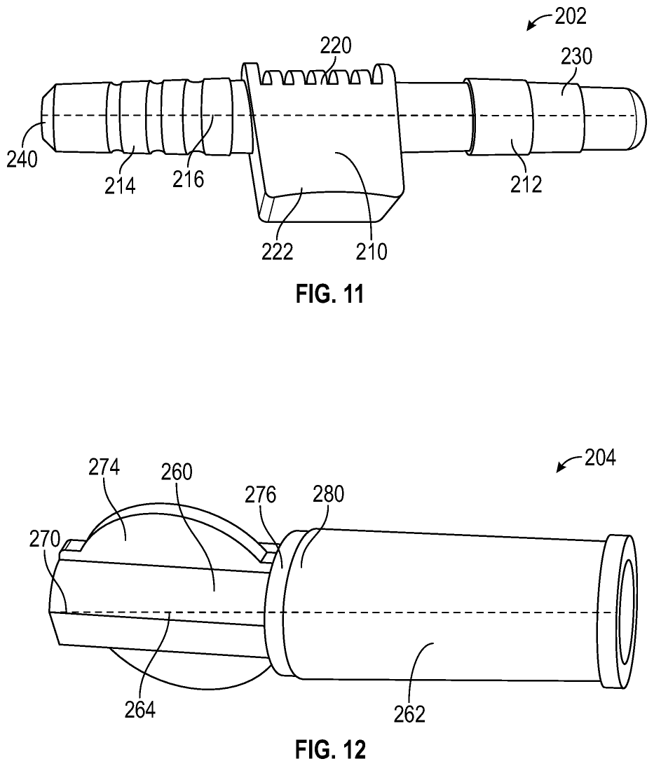

As shown in FIGS. 9-11, the first portion 202 includes a base 210, a plug connector 212, an adapter connector 214 (visible only in FIGS. 10-11), and a first lumen 216 (shown as dotted line). The first portion 202 is shown alone in FIG. 11, though it is noted that the first portion 202 is only used when connected with second portion 204 in the first configuration (whereas in the second configuration, second portion 204 may be used alone). The plug connector 212 is shown to extend away from the base 210 in a first direction, and the adapter connector 214 is shown to extend away from the base 210 is a second direction (e.g., opposite direction). In an exemplary embodiment, the plug connector 212 is configured to couple a component (e.g., a flexible tube) of a first fluid flow device, such that the oral care coupling 200 fluidly couples an oral care device and the first fluid flow device. The adapter connector 214 may be configured to selectively couple the second portion 204 to the first portion 202. As shown in FIGS. 9-11, the first lumen 216 is positioned within components of the first portion 202, and extends from the plug connector 212, through the base 210, and to the adapter connector 214. According to an exemplary embodiment, the first lumen 216 is configured to enable routing of fluid through the first portion 202, for example when the oral care coupling 200 is coupled between an oral care device and a fluid flow device.

As shown in FIGS. 9-11, the base 210 includes one or more grips 220 and a base port 222. According to an exemplary embodiment, the base 210 (e.g., the grips 220, base port 222, etc.) is integrally coupled with the plug connector 212 and the adapter connector 214, and is formed of polypropylene or another rigid plastic. In an exemplary embodiment, the grips 220 include one or more extending ribs, and the grips 220 are configured to facilitate gripping or handling of the first portion 202 (e.g., by a healthcare provider, etc.). The grips 220 may be of varying radii, and may be configured to mimic the shape and/or conform to a hand (e.g., of a healthcare provider, etc.). The base port 222 (e.g., a thumb port, etc.) may be positioned on a top portion of the base 210, and may be fluidly coupled to the first lumen 216 (e.g., at the base 210). According to an exemplary embodiment, the base port 222 is configured to enable movement (e.g., suction, etc.) of fluid through the first portion 202 (e.g., the first lumen 216). For example, the first portion 202 (e.g., the plug connector 212) may be fluidly coupled to one or more fluid flow devices (e.g., suction device, vacuum, a reservoir, etc.), such that the first lumen 216 is in fluid communication with the fluid flow device. The base port 222 is configured for a user's thumb to cover the port such that the closed base port 222 facilitates suction of fluid through the first portion 202. In other embodiments, the base port 222 may be coupled to a closed suction system (e.g., swivel elbow closed suction system, a plug, etc.), such that the closed base port 222 facilitates suction of fluid through the first portion 202. It should be understood that while the base 210 is described as being formed of polypropylene and having certain components and/or configurations, it is contemplated that the base 210 may be formed of another suitable material and/or contain additional, fewer, and/or different components.

As shown in FIGS. 9-11, the plug connector 212 includes a connection interface 230, according to an exemplary embodiment. As discussed above, the plug connector 212 extends from the base 210 in a first direction (e.g., a longitudinal direction opposite the adapter connector 214), and is configured to couple a component (e.g., a flexible tube) of a first fluid flow device. In an exemplary embodiment, the connection interface 230 includes one or more ridges, and is configured to ensure adequate coupling between the plug connector 212 and a component (e.g., a flexible tube) of the first fluid flow device. For example, the connection interface 230 may include elevated ridges forming a stair-step interface, which may engage a flexible tube of the first fluid flow device. In other embodiments, the connection interface 230 includes other components (e.g., a ridge, concentric ridges, ridges spaced along the plug connector 212, etc.), and/or is any other suitable interface configured to engage a component (e.g., flexible tube) of the first fluid flow device. It should be understood that while the plug connector 212 is described as being formed of polypropylene and having certain components and/or configurations, it is contemplated that the plug connector 212 may be formed of another suitable material and/or include additional, fewer, and/or different components.

As shown in FIGS. 10-11, the adapter connector 214 includes an adapter interface 240, according to an exemplary embodiment. As discussed above, the adapter connector 214 extends from the base 210 in a second direction (e.g., a longitudinal direction opposite the plug connector 212), and is configured to selectively couple with the second portion 204 and/or components thereof. In an exemplary embodiment, the adapter interface 240 is configured to couple/de-couple with an adapter of the second portion 204. The adapter interface 240 may include perforated, meshed, head-foot, bonded, hinged, walled, etc. coupling features for coupling/de-coupling the adapter interface 240 to/from an adapter of the second portion 204. As will be discussed in greater detail below, in an exemplary embodiment the first portion 202 and the second portion 204 are machined as a single component (e.g., a unitary component), and the adapter interface 240 de-couples the second portion 204, for example in response to manipulation of a component of the oral care coupling 200 (e.g., the first portion 202, the second portion 204, a combination thereof, etc.). It should be understood that while the adapter connector 214 is described as being formed of polypropylene and having certain components and/or configurations, it is contemplated that the adapter connector 214 may be formed of another suitable material and/or include additional, fewer, and/or different components.

According to an exemplary embodiment, the first lumen 216 is positioned within components of the first portion 202, and extends from the plug connector 212, through the base 210, and to the adapter connector 214. The first lumen 216 may be in fluid communication with one or more ports, for example to facilitate movement of a fluid through the first portion 202 (e.g., the first lumen 216). According to an exemplary embodiment, the first lumen 216 is in fluid communication with a first port at an end of the plug connector 212, which enables fluid coupling of the first portion 202 to one or more fluid flow devices (e.g., suction device, fluid vacuum, a reservoir, etc.). The first lumen 216 may also be in fluid communication with a second port at an end of the adapter connector 214, which may enable fluid coupling of the first portion 202 to the second portion 204 and/or an oral care device. In some embodiments, the first portion 202 includes the first lumen 216 and one or more additional lumens (e.g., a second lumen, a third lumen, etc.) that may be coupled to one or more fluid flow devices and/or an oral care device, so as to enable routing of fluid through the first portion 202 (e.g., to/from one or more fluid flow devices). It should be understood that while the first lumen 216 is described as having certain components and/or configurations, it is contemplated that the first lumen 216 may include additional, fewer, and/or different components.

Referring to FIGS. 9-10 and 12, the second portion 204 is shown to include an adapter 260 and a second lumen 264 in communication with first lumen 216. In an exemplary embodiment, the adapter 260 is configured to selectively couple (e.g., couple/de-couple) with an oral care device, such that the second portion 204 is configured to fluidly couple an oral care device and one or more fluid flow devices, as discussed below. In an exemplary embodiment, the adapter 260 includes adapter coupler 262 at the first end (e.g., an end opposite the oral care device). In some embodiments, the adapter coupler 262 is configured to couple with a component (e.g., a rigid connector) of a second fluid flow device, such that the second portion 204 fluidly couples an oral care device with a second fluid flow device. As shown in FIGS. 9-10, the second lumen 264 is positioned within components of the second portion 204 (e.g., the adapter 260). The second lumen 264 may be configured to enable routing of fluid through the second portion 204, for example when the second portion 204 is coupled to an oral care device and/or a fluid flow device.

As shown in FIGS. 9-10 and 12, the adapter 260 includes an oral care device connector 270, a coupling interface 272, one or more adapter grips 274, and a coupler fitting 276. According to an exemplary embodiment, components of the adapter 260 (e.g., components 272-276) are integrally coupled, and formed of polypropylene or another rigid plastic. In an exemplary embodiment, the oral care device connector 270 is positioned at the second end of the adapter 260 (e.g., opposite the adapter coupler 262), and includes a coupling interface for coupling an oral care device. The coupling interface may be, for example, a plug, socket, pressure-fit, snap-fit, twist-lock, hinge, hook, etc., and/or any other suitable interface configured to couple one or more components of an oral care device (e.g., the oral care device 100, a toothbrush, etc.). In an exemplary embodiment, the coupling interface 272 is positioned at the first end of the adapter 260 (e.g., opposite the oral care device connector 270), and is configured to selectively couple the first portion 202 and/or components thereof (e.g., the adapter interface 240, etc.). For example, the coupling interface 272 may be configured to couple/de-couple the adapter interface 240 of the first portion 202. As discussed above, the coupling interface 272 may include perforated, meshed, head-foot, bonded, hinged, walled, etc. coupling features for coupling/de-coupling the coupling interface 272 to/from the adapter interface 240 of the first portion 202. In an exemplary embodiment, the coupling interface 272 and the adapter interface 240 are machined as a single component (e.g., a unitary component), and the coupling interface 272 de-couples the first portion 202, for example in response to manipulation of a component of the oral care coupling 200.

In an exemplary embodiment, the adapter grips 274 extend away from the adapter 260 and are configured to facilitate gripping or handling of the second portion 204 (e.g., by a healthcare provider, etc.). As shown in FIGS. 9-10 and 12, the adapter grips 274 may be semi-circular and substantially flat, and may extend from lateral sides of the adapter 260. In an exemplary embodiment, the adapter grips 274 are integrally formed with the adapter 260, such that the adapter grips 274 are configured to withstand a force applied to the adapter grips 274 (e.g., vertical force, horizontal force, rotational force, push/pull, etc.). It should be understood that while the adapter grips 274 are described herein as flat, integrally formed with adapter 260, and extending from lateral sides, the adapter grips 274 may be otherwise coupled to the adapter 260, formed of any suitable material, and/or include additional, fewer, and/or different components configured to facilitate gripping or handling of the second portion 204.

In an exemplary embodiment, the coupler fitting 276 is positioned at the first end of the adapter 260 (e.g., proximate the adapter coupler 262), and is configured to facilitate coupling of the adapter 260 to the adapter coupler 262. As shown in FIGS. 9-10 and 12, the coupler fitting 276 includes a plurality of ridges extending circumferentially around the adapter 260, and is configured to be received by one or more recesses in the adapter coupler 262. According to an exemplary embodiment, the coupler fitting 276 is of suitable height and/or formed of suitable material (e.g., polyethylene, rigid plastic, etc.), such that the coupler fitting 276 is configured to couple the adapter coupler 262 and withstand a force applied to the adapter 260 and/or adapter coupler 262 (e.g., rotational force, push/pull, etc.), for example when coupling an oral care device, a fluid flow device, etc. In an exemplary embodiment, the coupler fitting 276 is machined as part of the adapter 260, and couples the adapter coupler 262 when the adapter coupler 262 is machined (e.g., overmolded, etc.) to the adapter 260. It should be understood that while the coupler fitting 276 is described herein as including ridges extending circumferentially around the adapter 260, the coupler fitting 276 may incorporate different coupling features (e.g., projections, teeth, hooks, cavities, receiving interfaces, etc.), other configurations (e.g., a single feature, longitudinally, laterally, etc. extending), and/or any fewer, different, or different components configured to facilitate coupling of the adapter 260 to the adapter coupler 262.

As shown in FIGS. 9-10 and 12, the adapter coupler 262 includes a fitting receiver 280, and is configured to couple with the adapter 260. According to an exemplary embodiment, the fitting receiver 280 includes a plurality of recesses extending circumferentially around the adapter coupler 262, and is configured to receive the coupler fitting 276 (as shown in FIGS. 9-10). However, in other embodiments the fitting receiver 280 is another suitable receiver (e.g., projection, orifice, interface, etc.) configured to facilitate coupling of the adapter coupler 262 to the adapter 260. According to an exemplary embodiment, the adapter coupler 262 is an elongated cylinder, and is formed of polyolefin or another low durometer plastic. In other embodiments, the adapter coupler 262 is another suitable shape or configuration (e.g., elongated rectangle, includes hooks, loops, receivers, etc.) and/or is formed of another suitable material. As will be discussed below, in some embodiments the adapter coupler 262 is configured to couple (e.g., receive) a component (e.g., a rigid connector) of a fluid flow device. The adapter coupler 262 may include a device interface (not shown) on an interior surface of the adapter coupler 262. For example, the device interface may be a substantially flat surface, configured to deform so as to ensure adequate coupling between the second portion 204 and a component (e.g., a rigid connector) of a fluid flow device. In other embodiments, the device interface is of another configuration (includes a ridge, concentric ridges, ridges spaced along the adapter coupler 262, etc.), and/or includes additional, fewer, and/or different components configured to engage a component (e.g., a rigid connector) of the second fluid flow device.

According to an exemplary embodiment, the second lumen 264 is positioned within components of the second portion 204 (e.g., the adapter 260). The second lumen 264 may be in fluid communication with one or more ports, for example to facilitate movement of fluid through the second portion 204 (e.g., the second lumen 264). According to an exemplary embodiment, the second lumen 264 is in fluid communication with a first port at an end of the adapter 260, which enables fluid coupling of the second portion 204 to an oral care device. The second lumen 264 may also be in fluid communication with a second port at an end of the adapter 260, which may enable fluid coupling of the second portion 204 to the first portion 202 (e.g., via the first lumen 216) and/or a component of one or more fluid flow devices (e.g., suction device, fluid vacuum, a reservoir, etc.). In some embodiments, the second portion 204 includes the second lumen 264 and one or more additional lumens (e.g., a second lumen, a third lumen, etc.) that may be coupled to an oral care device, the first portion 202, and/or one or more fluid flow devices, so as to enable routing of fluid through the second portion 204. It should be understood that while the second lumen 264 is described as having certain components and configurations, it is contemplated that the second lumen 264 may include additional, fewer, and/or different components.

According to an exemplary embodiment, the oral care coupling 200 described herein is formed using an injection molding process. The oral care coupling 200 may be molded by filing a mold cavity with one or more materials, which when allowed to cure or cool may be shaped into the oral care coupling 200. In an exemplary embodiment, the mold cavity includes cavities and/or projections shaped as the inverse of components of the oral care coupling 200. The mold cavity may also receive one or more inserts, which may be used to fill one or more portions of the mold cavity. As discussed above, the mold may incorporate one or more mold design factors, such as runner and gate size, gate placement, venting and molding parameters, mold material or materials, etc. that affect the molded part (e.g., the oral care coupling 200). Components of the oral care coupling may be formed of polypropylene or another rigid plastic (e.g., acrylonitrile butadiene styrene, high-density polyethylene, polyether ether ketone, polyamide, polycarbonate, polyetherimide, polybutylene terephthalate, acrylic, polyoxymethylene, polypropylene, silicone, thermoplastic elastomers, thermoplastic polyurethane, thermoplastic rubber, etc.), polyolefin or another low durometer plastic, and/or any other suitable material. For example, in an exemplary embodiment a mold cavity (with or without a mold insert) is filled with polypropylene or another rigid plastic, which when allowed to cure or cool, is shaped into components of the oral care coupling 200 (e.g., the first portion 202, the adapter 260, second lumen 264, etc.). After the polypropylene or other plastic is allowed to cure or cool, the mold cavity (with or without an overmold insert) may be filled with polyolefin or another low durometer plastic. Upon curing or cooling, the polyolefin or other plastic may form additional components of the oral care coupling 200, for example the adapter coupler 262. In this regard, an injection mold may be used to form the oral care coupling 200, which includes a connector formed of a rigid plastic (e.g., the first portion 202), and an overmolded connector formed of a low durometer plastic (e.g., the second portion 204).

As an illustrative example, the oral care coupling 200 may be used to couple an oral care device to a first fluid flow device (e.g., a fluid flow device having a socket connection). According to an exemplary embodiment, the oral care coupling 200 is provided with the first portion 202 and the second portion 204 coupled as a unitary component (as shown in FIG. 9). As discussed above, the oral care coupling 200 may be machined such that the first portion 202 and the second portion 204 are a single component. In this regard, the adapter connector 214 may be coupled to the adapter 260 (e.g., the adapter interface 240 and the coupling interface 272 may be coupled), and the first lumen 216 may be in communication with the second lumen 264. According to an exemplary embodiment, the oral care coupling 200 is positioned (e.g., via the grips 220, adapter grips 274, etc.) relative to an oral care device and a first fluid flow device (e.g., suction device). A component of the first fluid flow device (e.g., a flexible tube) may be securely coupled to the first portion 202. In an exemplary embodiment, a flexible tube is coupled to the plug connector 212, for example by sliding the flexible tube over the plug connector 212 and engaging the elevated ridges of the connection interface 230. A component of the oral care device may also be securely coupled to the second portion 204. According to an exemplary embodiment, the oral care device is coupled to the oral care device connector 270, for example by a pressure-fit or snap-fit connection. According to an exemplary embodiment, the fluid flow device may be activated, and the fluid flow device may route fluid from an oral cavity of a patient, through the oral care device, the second portion 204 (e.g., the second lumen 264), the first portion 202 (e.g., the first lumen 216), and away to the suction device.

As another illustrative example, the oral care coupling 200 may be used to couple an oral care device to a second fluid flow device (e.g., a fluid flow device having a plug connection). According to an exemplary embodiment, the oral care coupling 200 is provided with the first portion 202 and the second portion 204 coupled as a unitary component (as shown in FIG. 9). The oral care coupling 200 may be securely grasped or handled (e.g., via the grips 220, adapter grips 274, etc.), and the adapter grips 274 may be manipulated (e.g., rotated, pushed, vertical force applied, etc.) such that the second portion 204 is repositioned relative to the first portion 202. According to an exemplary embodiment, manipulating of the adapter grips 274 causes second portion 204 and the first portion 202 to de-couple (shown in FIGS. 11-12). In this regard, the adapter connector 214 may be de-coupled from the adapter 260 (e.g., the adapter interface 240 and the coupling interface 272 may be de-coupled). In some embodiments, the second portion 204 is positioned (e.g., via adapter grips 274, etc.) relative to an oral care device and a second fluid flow device (e.g., a suction device), and the first portion 202 is discarded. A component of the second fluid flow device (e.g., a rigid connector) may be securely coupled to the second portion 204. In an exemplary embodiment, a rigid connector is coupled to (e.g., received by) the adapter coupler 262, for example by inserting the rigid connector into the adapter coupler 262 and engaging the device interface inside the adapter coupler 262. A component of the oral care device may also be securely coupled to the second portion 204. According to an exemplary embodiment, the oral care device is coupled to the oral care device connector 270, for example by a pressure-fit or snap-fit connection. According to an exemplary embodiment, the fluid flow device may be activated, and the fluid flow device may route fluid from an oral cavity of a patient, through the oral care device, through the second portion 204 (e.g., the second lumen 264), and away to the suction device.

According to an exemplary embodiment, any of the oral care devices, systems, and/or components described herein may be packaged individually or as a kit. In some embodiments, the kit includes one oral care device 100, oral care coupling 200, system, and/or component; however, in other embodiments the kit includes any number of oral care devices 100, oral care coupling 200, systems, and/or components (e.g., 2, 3, 5, 10, 15, 25, etc.). In other embodiments, the kit includes one or more oral care devices 100, oral care couplings 200, and/or any other suitable oral care tool or component. In this regard, a healthcare provider may receive a kit (e.g., an oral care device 100, an oral care coupling 200, etc.) that may be used for any suitable patient (e.g., independent, dependent, etc.), in combination with one or more fluid flow devices (e.g., having a socket port, having a plug port, etc.), and/or in different clinical settings throughout the world. According to an exemplary embodiment, the components of the kit are pre-packaged and/or arranged for use; however, in other embodiments the components of the kit are pre-package and may be adapted for use (e.g., the oral care coupling 200). In other embodiments, the packaging is designed with a small footprint for storage on a bedside table in a hospital room.

### Powered Oral Care Device

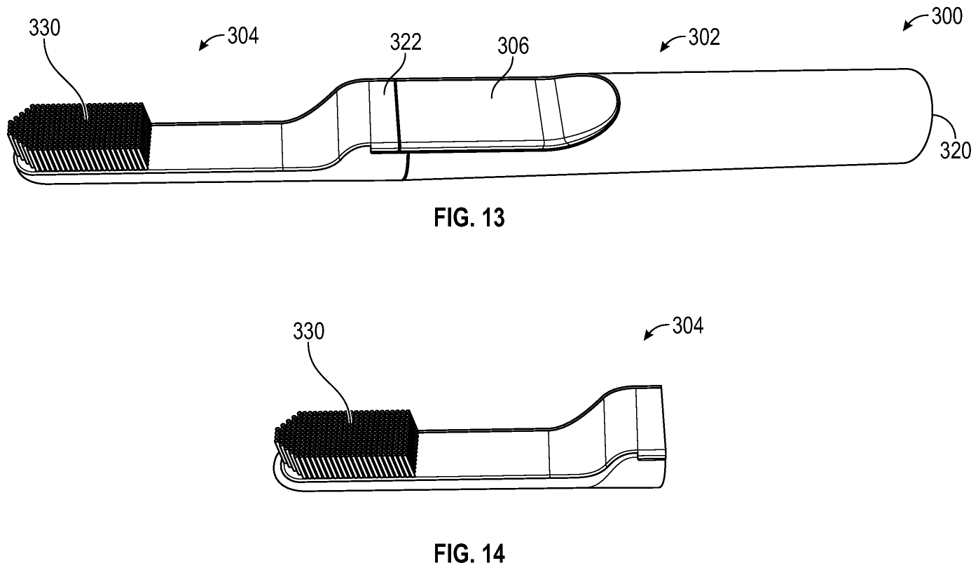

Referring now to FIGS. 13-14, an oral care device 300 is shown, according to an exemplary embodiment. In an exemplary embodiment, the oral care device 300 is, or includes one or more components of, the oral care device 100 of FIGS. 1-8, and/or is configured to be implemented with the oral care coupling 200 of FIGS. 9-12. According to an exemplary embodiment, the oral care device 300 is powered and/or configured to oscillate for cleaning the oral cavity of a patient. In this regard, the oral care device 300 may be, or include one or more components of, the oral care device 100 of FIGS. 1-2. As shown, the oral care device 300 includes a handle 302 and a cleaning head 304 configured to couple (as shown in FIG. 13) and/or de-couple with the handle 302 (as shown in FIG. 14). The handle 302 may be configured to enable a user (e.g., medical personnel) to grasp the oral care device 300, and the cleaning head 304 may be configured to fit within the oral cavity of a patient to facilitate cleaning of oral anatomy. In an exemplary embodiment, the oral care device 300 includes additional components configured to power and/or control use of the oral care device 300 (e.g., an oral care manager platform 306, a battery, a motor, an actuator, a sensor, a positioning device, etc.). In other embodiments, the oral care device 300 further includes components configured to allow for cleaning of the oral cavity of a patient using suction (e.g., a suction mount 308, one or more components of the oral care device 100 of FIGS. 1-8, etc.), as discussed below.

According to an exemplary embodiment, the handle 302 includes a first end 320 and a second end 322, and is configured to couple/de-couple with the cleaning head 304. As shown in FIG. 13, the handle 302 is elongated and substantially hollow, and is configured to house components configured to power and/or control use of the oral care device 300. For example, the handle 302 may include the oral care manager platform 306, which may be configured to control and/or monitor use of the oral care device 300. The handle 302 may also include a battery, a motor, an actuator, cams and/or gears, shafts, a circuit, a sensor, a positioning device, and/or other components configured to power the oral care device 300 and/or manipulate the handle 302 so as to oscillate the cleaning head 304. For example, the handle 302 may include a motor housed within the handle 302, the motor configured to manipulate (e.g., reciprocate, vibrate, oscillate, etc. via the cams, gears, shaft, etc.) to the handle 302 so as to oscillate the cleaning head 304. The second end 322 of the handle 302 may include a connection interface configured to couple/de-couple the cleaning head 304. The connection interface may include a snap-fit connection, a friction-fit connection, and/or any other suitable connection, and may include other components (e.g., a sensor, magnet, etc.) configured to determine when the handle 302 is coupled/de-coupled to/from the cleaning head 304. In an exemplary embodiment, the handle 302 is formed of biocompatible plastic and/or polymer, and is configured to be easily cleaned and/or sanitized. In some embodiments, the first end 320, the second end 322, and/or another suitable component of the handle 302 (e.g., a base, body, first surface, second surface, etc.) include additional, fewer, and/or or different components (e.g., a receiver, a mount, a sensor, a magnet, etc.).

According to an exemplary embodiment, the cleaning head 304 includes one or more cleaning elements, shown as bristles 330, and is configured as a non-suction cleaning head. As shown, the cleaning head 304 is elongated and substantially planar (as shown in FIG. 14); however, in other embodiments the cleaning head 304 is bent, angled, and/or curved, for example to allow for easier application of a cleaning solution during cleaning of the oral cavity of a patient. According to an exemplary embodiment, the cleaning head 304 includes a counterpart connection interface configured to couple/de-couple the handle 302 (e.g., the connection interface of the handle 302). The counterpart connection interface may include a snap-fit connection, a friction-fit connection, and/or any other suitable connection, and/or may include other components (e.g., a sensor, magnet, etc.) configured to indicate when the cleaning head 304 is coupled/de-coupled to/from the handle 302. Similar to the handle 302, the cleaning head 304 may be formed of biocompatible plastic and/or polymer, and may be configured to be easily cleaned and/or sanitized.

In an exemplary embodiment, the bristles 330 extend away from a first surface (e.g., top surface) of the cleaning head 304; however, in other embodiments, the bristles 330 extend away from another surface (e.g., a bottom surface) of the cleaning head 304. For example, the bristles 330 may be arranged on sides of the cleaning head 304, in a regular pattern surrounding the cleaning head 304, and/or in another suitable pattern at the cleaning head 304. The bristles 330 may be molded and/or formed of a biocompatible plastic and/or polymer (e.g., nylon, etc.). In other embodiments, the cleaning elements are foam, textured rubber, felt, and/or any other suitable material configured to retain and/or provide a cleaning solution for cleaning the oral cavity of a patient. In yet other embodiments, the cleaning elements include one or more bristle sections, one or more foam sections, one or more textured sections, etc., and/or any combination thereof.

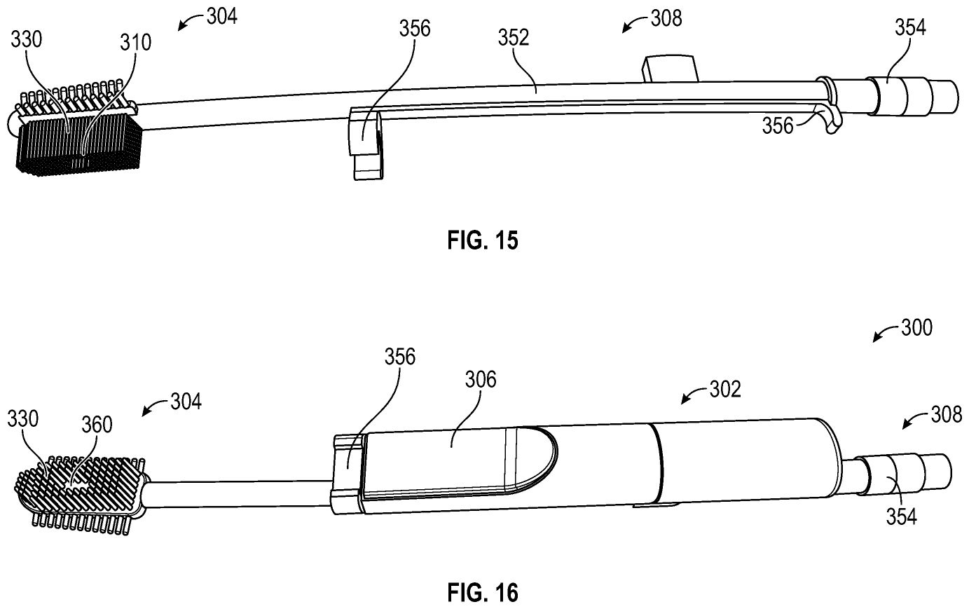

Referring now to FIGS. 15-16, the oral care device 300 of FIGS. 13-14 is shown, according to another exemplary embodiment. In an exemplary embodiment, the oral care device 300 includes the suction mount 308, which is configured to couple the handle 302 and/or provide suction when cleaning the oral cavity of a patient. In some embodiments, the suction mount 308 is, or includes one or more components of, the oral care device 100 of FIGS. 3-8, and/or is configured to be implemented with the oral care coupling 200 of FIGS. 9-12, as discussed below. As shown in FIGS. 15-16, the suction mount 308 includes an elongated base (shown as base 352) having a connection port 354 at a first end, and a plurality of mounts 356 positioned along the base 352. The base 352 may be integral with the cleaning head 304 at a second end (e.g., opposite the connection port 354), and the cleaning head 304 may be configured as a suction cleaning head. According to an exemplary embodiment, the base 352 includes a first lumen extending from the first end (e.g., the connection port 354) to the second end (e.g., the cleaning head 304), so as to allow fluid and/or a cleaning solution to move from the cleaning head 304, through the base 352, and to the connection port 354 when the oral care device 300 is used in cleaning the oral cavity of a patient. In this regard, the oral care device 300 may be configured to enable the suction of fluid from within the oral cavity, through the oral care device 300 (e.g., the first lumen of the suction mount 308), and away from the oral cavity. In some embodiments, the base 352 includes a second lumen extending from the first end (e.g., connection port 354) to the second end (e.g., cleaning head 304), the second lumen configured to provide a fluid (e.g., a cleaning solution, cleansing gel, etc.) to an oral site within the oral cavity of a patient (e.g., the cleaning head 304).

As discussed above, in some embodiments the components of the oral care device 300 of FIGS. 15-16 is, or include one or more components of, the oral care device 100 of FIGS. 3-8. For example, in some embodiments the base 352 is, or includes one or more components of, the neck portion 104 and/or the handle 102 of the oral care device 100 of FIGS. 3-8. The neck portion 104 and/or the handle 102 of the oral care device 100 of FIGS. 3-8 may include a plurality of mounts 356 positioned along the neck portion 104 and/or the handle 102. In some embodiments, the connection port 354 is the connection port 114 of the oral care device 100 of FIGS. 3-8, and/or is configured to be implemented with the oral care coupling 200 of FIGS. 9-12. The cleaning head 304 may be the cleaning head 106 of the oral care device 100 of FIGS. 3-8, and/or may include one or more of the cleaning elements configured to facilitate cleaning an oral cavity of a patient, as discussed above. It should be understood that while the oral care device 300 is described herein as having certain components and/or configurations, it is contemplated that the oral care device 300 may include additional, fewer, and/or different components (e.g., components of the oral care device 100 of FIGS. 1-8, etc.) and/or configurations configured to facilitate cleaning an oral cavity of a patient.

According to an exemplary embodiment, the base 352 is elongated and hollow (e.g., having a first lumen, a second lumen, etc.), and is configured to couple the handle 302. The base 352 may be formed of biocompatible plastic and/or polymer, and may be configured to be readily cleaned and/or sanitized. The base 352 is shown to include the connection port 354 at a first end. The connection port 354 may be configured to fluidly couple a fluid flow device (e.g., suction device, fluid vacuum, suction tube, etc.) and/or a component thereof (e.g., the oral care coupling 200 of FIGS. 9-12, a tube, etc.), such that the oral care device 300 (e.g., the first lumen) facilitates removal of fluid from the oral cavity of a patient during cleaning. In some embodiments, the connection port 354 includes a plurality of connection points, which are configured to fluidly couple a plurality of lumens of the oral care device 300 to a plurality of devices or components. For example, the connection port 354 may include a first connection point configured to fluidly couple the first lumen to a suction device (e.g., for removal of fluid from the oral cavity, etc.), and a second connection point configured to fluidly couple the second lumen to a fluid reservoir (e.g., having a cleaning solution or gel to provide to an oral cavity).

According to an exemplary embodiment, the base 352 includes the plurality of mounts 356, which are configured to couple/de-couple the base 352 to/from the handle 302. As shown, the plurality of mounts 356 may include two mounts, which may be spaced apart and/or positioned along the base 352. In an exemplary embodiment, the mounts 356 are configured to couple the handle 302, such that the base 352 is securely coupled to the handle 302, and the handle 302 is configured to move (e.g., reciprocate, vibrate, oscillate, etc.) the handle 302 and/or the base 352. As shown in FIG. 16, the mounts 356 extend away from the base 352, and a first mount 356 is configured to couple the first end 320 of the handle 302 and a second mount 356 is configured to couple the second end 322 of the handle 302. As discussed above, the first end 320 and/or the second end 322 of the handle 302 may include additional components (e.g., receiving notches, etc.), which may be configured to engage the mounts 356 so as to ensure the handle 302 is securely mounted to the base 352. In some embodiments, the handle 302 and/or the mounts 356 include additional components (e.g., a sensor, magnet, etc.), configured to indicate when the handle 302 is coupled/de-coupled to/from the suction mount 308. In other embodiments, the base 352 includes a single mount 356 or any suitable number of mounts 356 (e.g., three, four, etc.), and/or the mounts 356 are of any suitable configuration for coupling/de-coupling the base 352 to the handle 302 (e.g., via friction, snap-fit, compression, pressure, magnetic, etc.).

In an exemplary embodiment, the base 352 is integrally coupled to the cleaning head 304 at a second end of the base 352, and the cleaning head 304 is configured as a suction cleaning head. As shown in FIGS. 15-16, the cleaning head 304 includes one or more cleaning elements, shown bristles 330, and one or more suction ports 360. According to an exemplary embodiment, the cleaning head 304 is elongated and substantially planar; however, in other embodiments the cleaning head 304 is bent, angled, and/or curved. In an exemplary embodiment, the bristles 330 extend away from a first surface (e.g., top surface) and side surfaces (e.g., a first side, a second side, etc.) of the cleaning head 304. In some embodiments, the bristles 330 extend from another surface (e.g., a bottom surface), or a combination of surfaces of the cleaning head 304 (e.g., in a regular pattern around the cleaning head 304, etc.). In other embodiments, the cleaning elements include foam, textured rubber, felt, and/or any other combination of material and/or sections of material suitable for cleaning the oral cavity of a patient. According to an exemplary embodiment, the suction port 360 is positioned on a first surface of the cleaning head 304 (e.g., a top surface), and is in fluid communication with the first lumen of the base 352. In this regard, the suction port 360 may permit the removal of fluid and/or cleaning solution from the oral cavity of a patient (e.g., via the first lumen, the suction device, etc.). In some embodiments, the cleaning head 304 is configured as a non-suction cleaning head, and/or a suction or non-suction cleaning head having additional, fewer, and/or different components. Further, although the cleaning head 304 is shown in FIGS. 15-16 as being integrally coupled to the base 352, in some embodiments the cleaning head 304 is configured to couple/de-couple the base 352, as discussed below.

### Oral Care Services System Having Oral Care Manager Platform

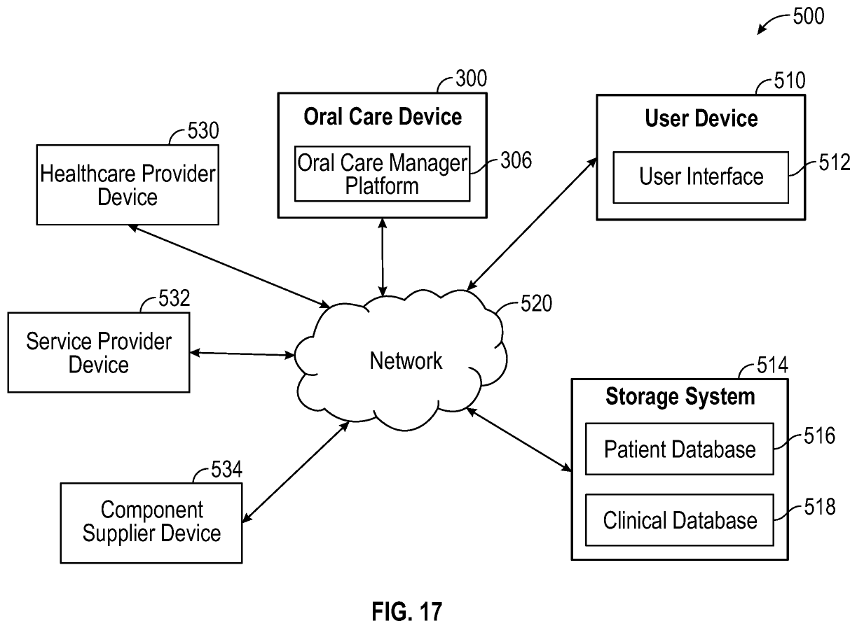

Referring now to FIG. 17, a block diagram of an oral care services system 500 is shown, according to an exemplary embodiment. The oral care services system 500 is shown to include an oral care device (e.g., shown as the oral care device 300) having the oral care manager platform 306, a user device 510 having a user interface 512, and a storage system 514 having a patient database 516 and a clinical database 518. The oral care services system 500 may also include a network 520, a healthcare provider device 530, a service provider device 532, and/or a component supplier device 534 (e.g., having one or more device interfaces). As will be discussed in greater detail below, the oral care manager platform 306 may be configured to obtain oral care data, generate a device use profile including information relating to use of the oral care device 300, and/or communicate the device use profile to an external device, for example to monitor and/or control use of the oral care device 300 in order to ensure safe and effective use. It should be understood that while the oral care manager platform 306 is described herein as obtaining, generating, communicating, etc. data relating to the oral care device 300, it is contemplated that the oral care manager platform 306 may be used with additional, fewer, and/or different oral care devices and/or tools, for example the oral care device 100 of FIGS. 1-2, the oral care device 100 of FIGS. 3-8, a device associated with the oral care coupling 200 of FIGS. 9-12, the second portion 204 of FIG. 12, and/or any other suitable oral care device and/or tool.

According to an exemplary embodiment, the oral care manager platform 306 is configured to communicate with components of the oral care services system 500. For example, the oral care manager platform 306 may communicate with the user device 510 and/or the storage system 514 (e.g., via the network 520). In some embodiments, the oral care manager platform 306 is configured to communicate with healthcare provider device 530, the service provider device 532, and/or the component supplier device 534 (e.g., via the network 520, one or more device interfaces, etc.).

As shown in FIG. 17, the oral care manager platform 306 is configured to communicate with the user device 510 (e.g., via the network 520). The user device 510 may include one or more human-machine interfaces or client interfaces, shown as the user interface 512 (e.g., a graphical user interface, reporting interface, text-based computer interface, client-facing web service, web servers that provide pages to a web client, etc.) for controlling, viewing, and/or otherwise interacting with the oral care manager platform 306. The user device 510 may be a mobile device or a stationary terminal. For example, the user device 510 may be a smartphone, a tablet, a PDA, a laptop computer, a desktop computer, a computer workstation, a client terminal, a computer server with an interface, a remote or local interface, and/or any other type of mobile or non-mobile user interface device.

In some embodiments, the oral care manager platform 306 is also configured to communicate with the storage system 514 (e.g., including the patient database 516, the clinical database 518), either directly (e.g., via the network 520) or indirectly (e.g., via the user device 510, etc.). The storage system 514 may include one or more devices (e.g., RAM, ROM, Flash memory, hard disk storage, etc.) for storing data and/or computer code for completing and/or facilitating various processes, layers, and modules described herein. The storage system 514 may be or include volatile memory or non-volatile memory, and may include database components, object code components, script components, and/or any other type of information structure for supporting the various activities and information structures described herein.

In other embodiments, the oral care manager platform 306 is configured to communicate with the healthcare provider device 530, the service provider device 532, and/or the component supplier device 534 (e.g., via the network 520). The healthcare provider device 530, the service provider device 532, and/or the component supplier device 534 may include one or more human-machine interfaces or client interfaces (e.g., a graphical user interface, reporting interface, text-based computer interface, client-facing web service, web servers that provide pages to a web client, etc.) for controlling, viewing, and/or otherwise interacting with the oral care manager platform 306. The healthcare provider device 530, the service provider device 532, and/or the component supplier device 534 may be a mobile device or a stationary terminal. For example, the healthcare provider device 530, the service provider device 532, and/or the component supplier device 534 may be a smartphone, a tablet, a PDA, a laptop computer, a desktop computer, a computer workstation, a client terminal, a computer server with an interface, a remote or local interface, and/or any other type of mobile or non-mobile user interface device.

According to an exemplary embodiment, and as will be discussed in greater detail below, the oral care manager platform 306 is also configured to generate data. For example, the oral care manager platform 306 may include components (e.g., an owner identification module 620, a device identification module 624, a device component module 628, a device location module 632, a device user module 636, a device security module 640, a device use module 644, a device use profile generator 648, and a device use database 652) that obtain, analyze, process, generate, store, and/or communicate data. The data generated by the oral care manager platform 306 may be analyzed, processed, stored, etc. along with data received from other data sources discussed above. Further, the oral care manager platform 306 may communicate data generated by the oral care manager platform 306. For example, the oral care manager platform 306 may provide information relating to use of the oral care device 300 to the user device 510 (e.g., for a nurse, physician, healthcare provider, etc. to monitor appropriate use by a patient), the storage system 514 (e.g., to process and/or store historic use, trends, etc. of a patient, a clinic, a hospital, etc.), the healthcare provider device 530 (e.g., for a healthcare provider to monitor compliance with guidelines, regulations, laws, etc.), the service provider device 532 (e.g., for a service provider to monitor compliance, etc.), a component supplier device 534 (e.g., for a supplier to monitor device status, provide replacement parts, etc.), and/or any other suitable device or system.

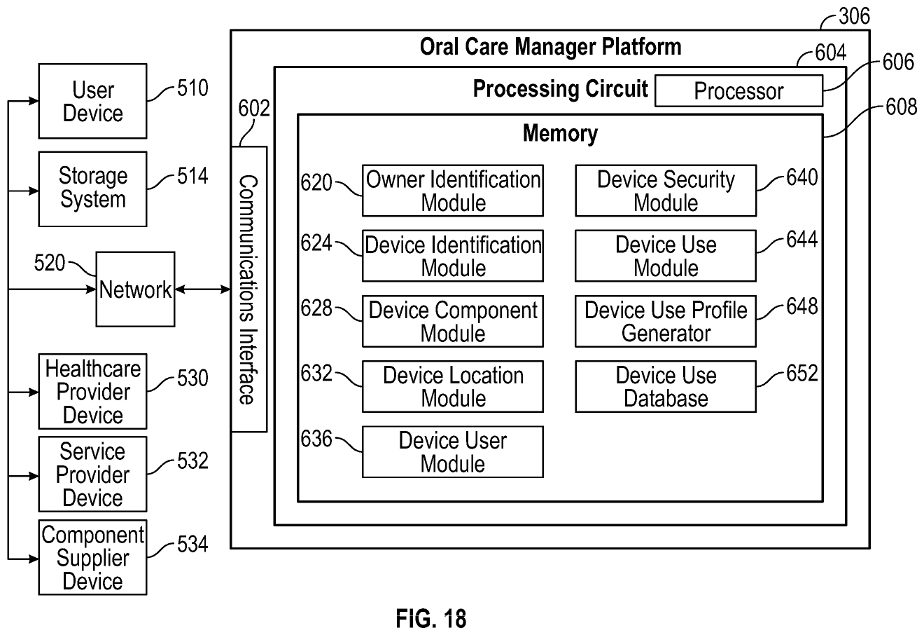

Referring now to FIG. 18, a block diagram illustrating the oral care manager platform 306 in greater detail is shown, according to an exemplary embodiment. The oral care manager platform 306 may be configured to obtain oral care data from the oral care device 300, and/or another suitable device or system (e.g., the user device 510, the storage system 514, the healthcare provider device 530, etc.). In an exemplary embodiment, the oral care data includes owner identification data, device data (e.g., device identification data, device component data, etc.), device location data, device user data, security data, device use data, and/or any other suitable data relating to the oral care device 300. The oral care manager platform 306 may store, process, modify, and/or communicate the oral care data, for example for additional processing. According to an exemplary embodiment, the oral care manager platform 306 generates a device use profile including information relating to use of the oral care device 300, and/or communicates the device use profile to an external device, for example to ensure appropriate, effective, and/or safe use of the oral care device 300.

As shown in FIG. 18, the oral care manager platform 306 is communicably connected to the user device 510 and the storage system 514 (e.g., via the network 520). In some embodiments, the oral care manager platform 306 is communicably connected to the healthcare provider device 530, the service provider device 532, and/or the component supplier device 534 (e.g., via the network 520). It should be understood that some or all of the components of the oral care manager platform 306, the user device 510, the storage system 514, etc. may be implemented as part of a cloud-based computing system configured to receive, process, and/or communicate data from one or more external devices or sources. Similarly, some or all of the components of the oral care manager platform 306, the user device 510, the storage system 514, etc. may be implemented within a single device, or distributed across multiple separate systems or devices. In some embodiments, some or all of the components of the oral care manager platform 306 are components of a subsystem level controller, a plant controller, a device controller, a field controller, a computer workstation, a client device, and/or another system or devices that receives, processes, and/or communicates data from/to devices or other data sources.

The oral care manager platform 306 is shown to include a communications interface 602 and a processing circuit 604 having a processor 606 and a memory 608. The communications interface 602 may include wired or wireless communications interfaces (e.g., jacks, antennas, transmitters, receivers, transceivers, wire terminals, etc.) for communicating data between the oral care manager platform 306 and external systems or devices (e.g., the user device 510, storage system 514, etc.). In some embodiments, the communications interface 602 facilitates communication between the oral care manager platform 306 and external applications (e.g., remote systems and applications), so as to allow a remote entity or user to control, monitor, and/or adjust components of the oral care manager platform 306. Communications conducted via the communications interface 602 may be direct (e.g., local wired or wireless communications), or via the network 520 (e.g., a WAN, the Internet, a cellular network, etc.). Further, the communications interface 602 may be configured to communicate with external systems and/or devices using any of a variety of communications protocols (e.g., HTTP(S), WebSocket, CoAP, MQTT, etc.), industrial control protocols (e.g., MTConnect, OPC, OPC-UA, etc.), process automation protocols (e.g., HART, Profibus, etc.), home automation protocols, and/or any of a variety of other protocols (e.g., Bluetooth, etc.). Advantageously, oral care manager platform 306 may obtain, ingest, and process data from any type of system or device, regardless of the communications protocol used by the system or device.

According to an exemplary embodiment, the oral care manager platform 306 communicates with the user device 510 (e.g., via the communications interface 602, the network 520, etc.). For example, the oral care manager platform 306 may obtain oral care data from the user device 510, which may include data received via the user interface 512 (e.g., input via a user, nurse, physician, healthcare provider, etc.). As will be discussed in greater detail below, the oral care manager platform 306 may obtain oral care data that includes owner identification data, device user data, and/or any other suitable data relating to use of the oral care device 300. In an exemplary embodiment, the oral care manager platform 306 is further configured to process, store, and/or communicate information relating to the oral care data (e.g., a device use profile, etc.) to other components of the oral care services system 500 (e.g., the user device 510).

In an exemplary embodiment, the oral care manager platform 306 also communicates with the storage system 514, the healthcare provider device 530, the service provider device 532, the component supplier device 534, and/or any other suitable device or system. The storage system 514 includes the patient database 516 and the clinical database 518 (as shown in FIG. 17), which may receive, store, and/or communicate data relating to use of the oral care device 300 (and/or a plurality of oral care devices 100). In an exemplary embodiment, the oral care manager platform 306 obtains oral care data from the healthcare provider device 530, the service provider device 532, and/or the component supplier device 534. For example, the oral care manager platform 306 may obtain owner identification data, device user data, etc. from the healthcare provider device 530 and/or the service provider device 532, and/or device data (e.g., device identifying data, device component data, etc.) from the component supplier device 534.

The oral care manager platform 306 is generally shown to include the processing circuit 604 having the processor 606 and the memory 608. While shown as single components, it will be appreciated that the oral care manager platform 306 may include one or more processing circuits including one or more processors and memory. In some embodiments, the oral care manager platform 306 includes a plurality of processors, memories, interfaces, and other components distributed across multiple devices or systems that are communicably coupled. For example, in a cloud-based or distributed implementation, the oral care manager platform 306 may include multiple discrete computing devices, each of which includes a processor 606, memory 608, communications interface 602, and/or other components of the oral care manager platform 306 that are communicably coupled. Tasks performed by oral care manager platform 306 may be distributed across multiple systems or devices, which may be located within a single device. In other embodiments, the oral care manager platform 306 itself is implemented within a single computer (e.g., one server, one housing, etc.). All such implementations are contemplated herein.

The processor 606 may be a general purpose or specific purpose processor, an application specific integrated circuit (ASIC), one or more field programmable gate arrays (FPGAs), a group of processing components, or other suitable processing components. The processor 606 may further be configured to execute computer code or instructions stored in the memory 608 or received from other computer readable media (e.g., CDROM, network storage, a remote server, etc.).

The memory 608 may include one or more devices (e.g., memory units, memory devices, storage devices, etc.) for storing data and/or computer code for completing and/or facilitating the various processes described in the present disclosure. The memory 608 may include random access memory (RAM), read-only memory (ROM), hard drive storage, temporary storage, non-volatile memory, flash memory, optical memory, or any other suitable memory for storing software objects and/or computer instructions. In some embodiments, the memory 608 includes database components, object code components, script components, and/or any other type of information structure for supporting the various activities and information structures described in the present disclosure. The memory 608 may be communicably connected to the processor 606 via the processing circuit 604, and may include computer code for executing (e.g., by the processor 606) one or more processes described herein. When the processor 606 executes instructions stored in the memory 608, the processor 606 may generally configure the processing circuit 604 to complete such activities.

Referring still to FIG. 18, the oral care manager platform 306 is shown to include the owner identification module 620, the device identification module 624, the device component module 628, the device location module 632, the device user module 636, the device security module 640, the device use module 644, the device use profile generator 648, and the device use database 652. As discussed above, the oral care manager platform 306 (e.g., components 620-652) may obtain oral care data from the oral care device 300, and/or another suitable device or system (e.g., the user device 510, the storage system 514, the healthcare provider device 530, etc.). The oral care data may include, for example, owner identification data, device data (e.g., device identifying data, device component data, etc.), device location data, device user data, device use data, and/or any other suitable data relating to the oral care device 300. In some embodiments, the oral care manager platform 306 (e.g., components 620-652) is configured to store, process, modify, and/or communicate the oral care data, for example for additional processing. In an exemplary embodiment, the oral care manager platform 306 (e.g., components 620-652) generates a device use profile including information relating to use of the oral care device 300, and/or communicates the device use profile to an external device (e.g., the user device 501, the storage system 514, etc.), for example to ensure appropriate and safe use of the oral care device 300.

According to an exemplary embodiment, the owner identification module 620 is configured to obtain owner identification data. Owner identification data may be obtained from the user device 510 (e.g., input from a user, an attending nurse, etc. via the user interface 512), the storage system 514 (e.g., via patient logs in the patient database 516, clinical logs in the clinical database 518, etc.), the healthcare provider device 530 (e.g., via input from a healthcare provider, etc.), the service provider device 532, and/or any other suitable device or system. According to an exemplary embodiment, owner identification data includes information relating to and/or identifying the owner (e.g., a patient) or entity using the oral care device 300. For example, owner identification data may include the name, age, gender, height, weight, address, phone number, medical condition or conditions, health risks, etc. of a patient using the oral care device 300. In an exemplary embodiment, the owner identification module 620 stores owner identification data of the patient using the oral care device 300, and/or communicates owner identification data to one or more components of the oral care manager platform 306, for example for additional processing.

In an exemplary embodiment, the device identification module 624 is configured to obtain device data. According to an exemplary embodiment, the device identification module 624 obtains device data from components of the oral care device 300 (e.g., a processor, memory, etc. upon manufacturing, setup, a software upgrade and/or update, etc.). Device data may also be obtained from the user device 510, the healthcare provider device 530, the component supplier device 534, and/or any other suitable device or system (e.g., input via a user, etc.). According to an exemplary embodiment, device data includes identifying information relating to the oral care device 300 (and/or the oral care device 100 of FIGS. 1-8). For example, device data may include a unique device identity code (e.g., of the oral care device 300, an alphanumeric code, etc.), a unique component identity code (e.g., of the handle 302, an alphanumeric code, etc.), and/or a combination thereof. Further, the device data may include additional identifying characteristics of the oral care device 300 (e.g., make, model, year, etc.). In an exemplary embodiment, the device identification module 624 stores device data identifying the oral care device 300, and/or communicates device data to one or more components of the oral care manager platform 306.

In an exemplary embodiment, the device component module 628 is also configured to obtain device data. As discussed above, device data may be obtained from components of the oral care device 300 (e.g., a processor, memory, sensor, etc.). In other embodiments, device data is obtained from the user device 510, the healthcare provider device 530, the component supplier device 534, and/or any other suitable device or system (e.g., input via a user, etc.). According to an exemplary embodiment, device data also includes characteristics of a device component or part. For example, device data may include data indicating whether the cleaning head 304 is suction or non-suction (e.g., the cleaning head 106 of the oral care device 100 of FIGS. 3-8, the cleaning head 106 of the oral care device 100 of FIGS. 1-2, another cleaning head, etc.), the type of cleaning head 304 (e.g., toothbrush, foam, mouth guard, etc.), the type of cleaning elements of the cleaning head 304 (e.g., bristles, foam, textured, etc.), maximum or minimum suction power of the oral care device 300, maximum or minimum motor, battery charge or power, and/or any other suitable information relating to a component of the oral care device 300. In other embodiments, the device data includes characteristics of an oral care device or tool that is implemented with the oral care device 300. For example, device data may include characteristics of a coupling coupled to the oral care device 300 (e.g., the oral care coupling 200 of FIGS. 9-12, the second portion 204 of FIG. 12, etc.), a fluid flow device in communication with the oral care device 100 (e.g., a suction device, vacuum device, reservoir, etc.), and/or any other suitable characteristics of an oral care device or tool implemented with the oral care device 300. In an exemplary embodiment, the device component module 628 stores device data relating to one or more components of the oral care device 300, and/or communicates device data to one or more components of the oral care manager platform 306.

In an exemplary embodiment, the device location module 632 is configured to obtain device location data. According to an exemplary embodiment, the device location data is obtained from components of the oral care device 300 (e.g., a positioning device, global positioning device, etc.). According to an exemplary embodiment, location data includes location information relating to the oral care device 300. For example, location data may include global positioning coordinates of the oral care device 300, positioning coordinates of the oral care device 300 within a healthcare facility (e.g., during outpatient care), a hospital (e.g., during inpatient care), a house of the patient (e.g., post-discharge), etc., and/or any other suitable location data. In an exemplary embodiment, the device location module 632 obtains device location data while the oral care device 300 is in use; however, in other embodiments the device location module 632 obtains device location data periodically (e.g., every 30, 60, 90, etc. minutes, every 1, 2, 5, 10, etc. hours, etc.), continuously, when the oral care device is implemented with an oral care device or tool (e.g., the oral care coupling 200 of FIGS. 9-12), and/or at any other suitable interval or time. In an exemplary embodiment, the device location module 632 stores location data relating to the oral care device 300, and/or communicates location data to one or more components of the oral care manager platform 306.

In an exemplary embodiment, the device user module 636 is configured to obtain device user data. According to an exemplary embodiment, the device user data is obtained from components of the oral care device 300 (e.g., a proximity sensor, an RFID tag, a memory, etc.). In some embodiments, the device user data is obtained from the user device 510 (e.g., input from an attending nurse, user, etc. via the user interface 512), the storage system 514 (e.g., via a patient log stored in the patient database 516, etc.), the healthcare provider device 530 (e.g., via an attending healthcare provider log, etc.), and/or any other suitable device or system. According to an exemplary embodiment, device user data includes information relating to the user of the oral care device 300. For example, device user data may include information relating to an independent patient capable of using the oral care device 300 independently (e.g., name, age, address, phone number, etc.), information relating to an attending nurse or caregiver, information relating to a supervising physician (e.g., name, occupation, qualifications, certifications, trainings, etc.), and/or any other suitable information relating to the device user of the oral care device 300. In an exemplary embodiment, the device user module 636 stores device user data, and/or communicates device user data to one or more components of the oral care manager platform 306.

In an exemplary embodiment, the device security module 640 is configured to obtain security data. According to an exemplary embodiment, the security data is obtained from the user device 510 (e.g., input from an attending nurse, supervising physician, etc. via the user interface 512), the healthcare provider device 530 (e.g., via compliance documents or guidelines, etc.), the component supplier device 534 (e.g., via manufacturing and/or design restrictions or regulations, etc.), and/or any other suitable device or system. According to an exemplary embodiment, security data includes security protocols or restrictions relating to the oral care device 300 and/or a user of the oral care device 300. For example, security data may include fault thresholds of one or more components of the oral care device 300 (e.g., maximum suction power of the cleaning head 304, maximum output of the motor, etc.), activity timeouts of the oral care device 300 (e.g., 30, 60, 90, etc. seconds), warning indicators (e.g., inappropriate use warning, inactivity indicator, etc.), maintenance or replacement indicators (e.g., component part failure, component part overuse, etc.), and/or any other suitable security protocol or restriction. In an exemplary embodiment, the device security module 640 is configured to store security data. In some embodiments, the device security module 640 communicates security data to an external device (e.g., the user device 510, the healthcare provider device 530, the service provider device 532, the component supplier device 534, etc.), for example to ensure appropriate and safe use of the oral care device 300. In other embodiments, the device security module 640 also communicates security data to one or more components of the oral care manager platform 306.

In an exemplary embodiment, the device use module 644 is configured to obtain device use data. According to an exemplary embodiment, device use data is obtained from components of the oral care device 300 (e.g., a processor, memory, sensor, etc.) when the oral care device 300 is used. According to an exemplary embodiment, device use data includes information relating to use of the oral care device 300. For example, device use data may include information relating to the date, time, duration of use, device setting or settings, device cleaning regiment or protocol, etc. when the oral care device 300 is used. In an exemplary embodiment, the device use module 644 stores device use data, and/or communicates device use data to one or more components of the oral care manager platform 306.

In an exemplary embodiment, the device use profile generator 648 is configured to obtain data from components of the oral care manager platform 306 and/or other devices or systems. The device use profile generator 648 may obtain data from components of the oral care manager platform 306, for example before, during, and after use of the oral care device 300. For example, the device use profile generator 648 may obtain owner identification data from the owner identification module 620, device data identifying the oral care device 300 from the device identification module 624, and/or device data relating to one or more components of the oral care device 300 from the device component module 628. The device use profile generator 648 may further obtain device location data from the device location module 632, device user data from the device user module 636, security data from the device security module, and/or device use data from the device use module 644. In other embodiments, the device use profile generator 648 obtains other suitable data relating to the oral care device 300, a patient and/or user of the oral care device 300, a security protocol and/or safety regulation relating to the oral care device 300 and/or a patient or user, and/or any other suitable data.

According to an exemplary embodiment, the device use profile generator 648 is also configured to generate and/or communicate a device use profile that may be used to monitor and/or control use of the oral care device 300. In an exemplary embodiment, the device use profile includes information relating to use of the oral care device 300. For example, a device use profile may include identifying information of the owner (e.g., patient) of the oral care device 300, a unique device identity code associated with the oral care device 300, and/or characteristics of one or more components of the oral care device 300. Further, a device use profile may include location information of the oral care device 300 when the device is used, identifying information of the user of the oral care device 300, security protocols or restrictions initiated by the oral care device 300 (e.g., before, during, or after use), and/or the date, time, and duration of use of the oral care device 300. In this regard, a device use profile may represent parameters and/or pieces of information relating to use of the oral care device 300. In an exemplary embodiment, the device use profile generator 648 generates and/or communicates a device use profile each time the oral care device 300 is used. In some embodiments, the device use profile generator 648 generates and/or communicates a device use profile periodically (e.g., 2, 4, 12, 24, etc. hours), which may include a plurality of uses of the oral care device 300. The device use profile generator 648 may generate and/or communicate a device use profile (or a plurality of device use profiles) to the device use database 652 for storing and/or processing, for example for subsequent analysis and/or review.

As an illustrative example, the device use profile generator 648 may obtain owner identification data (e.g., identifying information of the owner or patient), and/or device identifying data (e.g., a unique device identity code of the oral care device 300) from components of the oral care manager platform 306, for example prior to use. Upon setup of the oral care device 300, the device use profile generator 648 may also obtain device component data (e.g., type of cleaning head 304, cleaning head 106, battery charge, oral care coupling 200, etc.) from components of the oral care manager platform 306. In an exemplary embodiment, when the oral care device 300 is activated for use, the device use profile generator 648 obtains device location data indicating the location of the oral care device 300, device user data indicating the user of the oral care device 300, and/or any security protocols or restrictions relating to use of the oral care device 300 (and/or patient or user) from components of the oral care manager platform 306. After the oral care device 300 is used to clean the oral cavity of a patient, the device use profile generator 648 may also obtain device use data indicating the date, time, duration, type of cleaning setting, etc. of use of the oral care device 300 from components of the oral care manager platform 306. The device use profile generator 648 may process the aforementioned data obtained from components of the oral care manager platform 306, and generate a device use profile having information relating to the particular use of the oral care device 300. The device use profile generator 648 may communicate the device use profile (or a plurality of device use profiles) to an external device or system (e.g., via the network 520, internet, Bluetooth, etc.), as discussed below.

In an exemplary embodiment, the device use profile generator 648 is configured to communicate one or more device use profiles to the user device 510 (e.g., via the user interface 512). The user device 510 may receive a device use profile, and/or display the device use profile (e.g., via the user interface 512) to a user. In this regard, the user device 510 may receive and/or display a device use profile, so as to notify a user of use of the oral care device 300. For example, upon discharge from a healthcare facility (e.g., hospital), an independent patient may receive the oral care device 300, and be instructed to periodically clean their oral cavity. Upon use of the oral care device 300 by the independent patient, the oral care device 300 (e.g., the oral care manager platform 306) may communicate a device use profile to the user device 510, which may be displayed on the user interface 512. A user of the user device 510 (e.g., attending caregiver, nurse, etc.) may receive and/or review the device use profile, for example to determine whether the independent patient is complying with appropriate use and/or safety instructions. In some embodiments, the user device 510 (e.g., the user interface 512) is used to communicate and/or otherwise interact with the oral care device 300, for example to provide an indication (e.g., reminder, warning, etc.) to the oral care device 300 regarding appropriate use of the oral care device 300.

In some embodiments, the device use profile generator 648 is configured to communicate one or more device use profiles to the storage system 514. For example, the device use profile generator 648 may communicate one or more device use profiles to the patient database 516 and/or the clinical database 518. In an exemplary embodiment, the patient database 516 may receive and store one or more device profiles from the oral care device 300. In this regard, the patient database 516 may be configured to receive, process, and/or store device profiles, for example in a patient log, which may be used to monitor and/or track use of the oral care device 300 by a specific patient. In other embodiments, the clinical database 518 receives and stores one or more device profiles from one or more oral care devices 100. In this regard, the clinical database 518 may be configured to receive, process, and/or store device profiles, for example in a clinical log, which may be used to monitor and/or track the use of one or more oral care devices 100 by patients (e.g., in a clinic, caregiving facility, etc.).

In other embodiments, the device use profile generator 648 is configured to communicate one or more device use profiles to the healthcare provider device 530. The healthcare provider device 530 may receive a device use profile, and/or display the device use profile to a healthcare provider. In some embodiments, the healthcare provider device 530 receives and/or displays device use profiles from one or more oral care devices 100 within a healthcare facility, as discussed below. In this regard, the healthcare provider device 530 may receive and/or display one or more device use profiles (e.g., of one or more oral care devices 100), so as to notify a healthcare provider of use of the oral care devices 100 within the healthcare facility. For example, upon intake into a healthcare facility (e.g., hospital, clinic, etc.), independent (e.g., non-suction oral care device) and dependent (e.g., suction oral care device) patients may receive an oral care device 300. Further, the attending caregiver, nurse, and/or healthcare provider may be instructed to ensure the oral cavities of the patients are periodically cleaned. Upon use of the oral care device 300 (e.g., by the patient, the attending caregiver, etc.), the oral care device 300 (e.g., the oral care manager platform 306) may communicate a device profile to the healthcare provider device 530. A healthcare provider with access to the healthcare provider device 530 (e.g., supervising physician, etc.) may receive and/or view the device use profile (or profiles), for example to determine whether the patient and/or attending caregiver is complying with appropriate use and/or safety instructions or guidelines. In some embodiments, the healthcare provider device 530 is also used to communicate and/or otherwise interact with one or more oral care devices 100 and/or the user device 510, for example to provide an indication (e.g., reminder, warning, etc.) regarding the appropriate use of the oral care device 300.

In yet other embodiments, the device use profile generator 648 is configured to communicate one or more device use profiles to the service provider device 532. The service provider device 532 may receive and/or display one or more device use profiles (e.g., from one or more oral care devices 100) from one or more healthcare facilities (e.g., hospitals, clinics, nursing homes, etc.). In this regard, the service provider device 532 may receive and/or display one or more device use profiles, so as to notify a service provider of use of the oral care devices 100 throughout various healthcare facilities. For example, upon intake into one or more healthcare facilities (e.g., within a service industry) patients may receive an oral care device 300. Further, healthcare providers, attending staff, and/or patients may be instructed to ensure the oral cavities of the patients are periodically cleaned (e.g., in accordance with safety or regulatory standards). Upon use of the oral care device 300, the oral care device 300 (e.g., the oral care manager platform 306) may communicate a device profile to the service provider device 532 (e.g., healthcare facility regulator, supervisor, etc.). A service provider with access to the service provider device 532 may receive and/or view the device use profiles, for example to determine whether a healthcare facility is complying with appropriate use and/or safety guidelines. In some embodiments, the service provider device 532 is used to communicate and/or otherwise interact with the healthcare provider device 530, the user device 510, and/or the oral care device 300, for example to provide an indication regarding the appropriate use of the oral care device 300.

In some embodiments, the device use profile generator 648 is configured to communicate one or more device use profiles to the component supplier device 534. The component supplier device 534 may receive, process, and/or display one or more device use profiles (e.g., from one or more oral care devices 100) from oral care devices the supplier provided and/or services. In this regard, the component supplier device 534 may receive and/or process device use profiles, so as to determine characteristics, states, and/or statuses of the oral care device 300 and/or components thereof. For example, upon manufacturing a supplier may categorize and/or catalogue the characteristics, statues, components, etc. of one or more oral care devices 100. As the oral care device 300 is used (e.g., via an independent patient, attending caregiver, etc.), the oral care device 300 (e.g., the oral care manager platform 306) may communicate a device use profile to the component supplier device 534. A supplier may receive and analyze the device use profile, for example to determine whether the oral care device 300, or one or more components thereof, need to be repaired, replaced, refurbished, etc. The component supplier device 534 may be used to communicate with the healthcare provider device 530, the user device 510, and/or a patient of the oral care device 300, for example to allow the suppler to repair, replace, refurbish, etc. one or more components of the oral care device 300.

As an illustrative example, one or more components of the oral care services system 500 may be used to control and/or monitor use of an oral care device. According to an exemplary embodiment, upon intake of a patient into a healthcare facility, the user device 510 (e.g., via the user interface 512) and/or the healthcare provider device 530 may be used to obtain patient information. Further, the patient may be assigned an oral care device, for example the oral care device 300, or a component thereof (e.g., the handle 302). Depending on the abilities of the patient, the oral care device 300 may be a non-suction device (e.g., the oral care device 300 of FIGS. 13-14, the oral care device 100 of FIGS. 1-2, etc.), a suction device (e.g., the oral care device 300 of FIGS. 15-16, the oral care device 100 of FIGS. 3-8, etc.), and/or any other suitable oral care device. According to an exemplary embodiment, after intake the oral care device 300 obtains owner identification data (e.g., patient information), which associates the oral care device 300 with the patient. In some embodiments, the oral care device 300 receives and/or stores device identifying data (e.g., a unique device identifying code). In this regard, the oral care device 300 may receive and/or store information that uniquely associates the oral care device 300 with the patient, and may be configured to track use of the oral care device 300 by the patient throughout the patient's treatment schedule (e.g., inpatient, outpatient, post-discharge, etc.).

After the oral care device 300 is associated with a patient, the oral care device 300 may be setup or prepared for use (e.g., treatment, cleaning, etc.). According to an exemplary embodiment, as the oral care device 300 is setup the oral care device 300 obtains device component data relating to one or more components of the oral care device 300. Device component data may include, for example, the type of cleaning head 304 coupled to the handle 302, the type of suction mount 308 coupled to the handle 302, the type of coupling coupled to the suction mount 308 (e.g., the oral care coupling 200, the second portion 204, etc.), the power source and/or output coupled to the handle 302, a battery charge, etc. Once the oral care device 300 is setup in preparation for treatment, the oral care device 300 may be used to clean the oral cavity of the patient.

In an exemplary embodiment, as the oral care device 300 is used, the oral care device 300 obtains location data indicating the location of the oral care device 300 (e.g., within the healthcare facility, a patient room, etc.), device user data indicating the user of the oral care device 300 (e.g., the patient, an attending nurse, a caregiver, unknown, etc.), and/or any other security measures or protocols relating to the oral care device 300 and/or the patient or user. Further, the oral care device 300 may obtain device use data, which may indicate the date, time, duration, cleaning setting, etc. of the oral care device 300 as the oral care device 300 is used to clean the oral cavity of the patient. Once treatment is complete, the oral care device 300 may generate a device use profile having information surrounding use of the oral care device 300. Further, the oral care device 300 may communicate the device use profile to the user device 510 (e.g., for review), the storage system 514 (e.g., for storage, logging, tracking historic data, etc.), and/or the healthcare provider device 530 (e.g., to ensure compliance with patient treatment schedules, oral care compliance guidance and/or regulations, etc.).

According to an exemplary embodiment, the oral care device 300 is configured to generate and/or communicate a device use profile each time the oral care device 300 is used to clean the oral cavity of the patient. In this regard, the oral care device 300 (e.g., the device use profiles) may be used to monitor, track, and/or document use of the oral care device 300 by the patient, so as to ensure compliance with a proper oral care regime, appropriate use of the oral care device 300, etc. while the patient is receiving treatment at the healthcare facility. According to an exemplary embodiment, upon discharge of the patient from the healthcare facility, the oral care device 300, or a component thereof (e.g., the handle 302), remains with the patient for at-home oral care treatment or cleaning. In an exemplary embodiment, the oral care device 300 is configured to generate and/or communicate a device use profile each time the oral care device 300 is used at home. In this regard, the oral care device 300 (e.g., the device use profiles) may also be used to monitor, track, and/or document use of the oral care device 300 by the patient at home, so as to ensure compliance with the oral care regime outside the healthcare facility.

According to an exemplary embodiment, any of the oral care devices, systems, and/or components described herein may be packaged individually or as a kit. In some embodiments, the kit includes one oral care device, system, and/or component; however, in other embodiments the kit includes any number of oral care devices, systems, and/or components (e.g., 2, 3, 5, 10, 15, 25, etc.). In this regard, a patient may receive a kit (e.g., an oral care device 300) upon intake into a healthcare facility, and/or a plurality of individual component kits (e.g., a cleaning head 304) may be provided in a patient room, for example for replacement. A healthcare provider may periodically check the kit for devices and/or components that may need to be repaired, replaced, refurbished, etc. According to an exemplary embodiment, the components of the kit are pre-packaged and/or arranged for use. In other embodiments, the packaging is designed with a small footprint for storage on a bedside table in a hospital room.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the systems, apparatuses, and methods shown in the various exemplary embodiments is illustrative only. Additionally, any element disclosed in one embodiment may be incorporated or utilized with any other embodiment disclosed herein. For example, any of the exemplary embodiments described in FIGS. 1-8 of this application can be incorporated with any of the other exemplary embodiment described in FIGS. 13-17 of the application. Although only one example of an element from one embodiment that can be incorporated or utilized in another embodiment has been described above, it should be appreciated that other elements of the various embodiments may be incorporated or utilized with any of the other embodiments disclosed herein.

1-43. (canceled)

44. An oral care coupling comprising:
a first portion comprising a plug connector; and
a second portion comprising an adapter and an adapter coupler extending from the adapter, wherein the adapter is configured to couple an oral care device;
wherein the oral care coupling is capable of a first configuration where the first portion and the second portion are coupled as a unitary piece, such that the unitary piece is configured to fluidly couple the oral care device and a first fluid flow device; and
wherein the oral care coupling is capable of a second configuration where the first portion and the second portion are de-coupled, such that the second portion is configured to fluidly couple the oral care device at the adapter and a second fluid flow device at the adapter coupler.

45. The oral care coupling of claim 44, wherein the plug connector is configured to couple a flexible tube of a fluid flow device.

46. The oral care coupling of claim 44, wherein the adapter coupler is configured to couple a rigid connector of a fluid flow device.

47. The oral care coupling of claim 44, wherein the first portion and the adapter of the second portion are formed of a first material.

48. The oral care coupling of claim 47, wherein the first material is polypropylene.

49. The oral care coupling of claim 44, wherein the adapter coupler of the second portion is formed of a second material.

50. The oral care coupling of claim 49, wherein the second material is polyolefin.

51. The oral care coupling of claim 44, wherein the first portion further comprises:
a base comprising a base port coupled to the plug connector, the base port configured to facilitate movement of a fluid through the oral care coupling; and
an adapter connector.

52. The oral care coupling of claim 51, wherein:
the base is integrally formed with the second portion;
the base further comprises:
a first rib having a first shape, and
a second rib having a second shape different from the first shape; and
the first rib and the second rib are configured to facilitate handling of the first portion.

53. The oral care coupling of claim 51, wherein:
the plug connector extends from the base in a longitudinal direction opposite of the adapter connector; and
the plug connector comprises a connection interface, the connection interface comprising a plurality of ridges, the plurality of ridges configured to facilitate engagement between the plug connector and the first fluid flow device.

54. The oral care coupling of claim 51, wherein:
the first portion further comprises a first lumen, the first lumen in fluid communication with the base port to facilitate movement of the fluid within the first portion; and
the first lumen is configured to route the fluid through the first portion to the second portion.

55. The oral care coupling of claim 54, wherein:
the second portion further comprises a second lumen, the second lumen positioned within the adapter and in fluid communication with the first lumen; and
the second lumen is configured to route the fluid through the second portion.

56. The oral care coupling of claim 44, wherein the adapter further comprises an adapter grip configured to be manipulated to facilitate de-coupling of the adapter from the first portion.

57. The oral care coupling of claim 44, wherein:
the first portion further comprises an adapter interface;
the second portion further comprises a coupling interface; and
the adapter interface and the coupling interface are configured to couple to form the unitary piece.

58. The oral care coupling of claim 57, wherein in response to manipulation of the oral care device, the adapter interface and the coupling interface are configured to de-couple such that the first portion and the second portion are configured to separate.

59. The oral care coupling of claim 44, wherein the first portion is integrally formed with the second portion.

60. The oral care coupling of claim 44, wherein:
the adapter comprises a coupler fitting having a plurality of ridges; and
the adapter coupler is overmolded on the plurality of ridges.

61. A kit comprising:
the oral care coupling of claim 44;
the oral care device;
the first fluid flow device; and
the second fluid flow device.

62. The kit of claim 61, wherein:
the first portion further comprises:
a base comprising a base port coupled to the plug connector, the base port configured to facilitate movement of a fluid through the oral care coupling, and
an adapter connector;
the plug connector extends from the base in a longitudinal direction opposite of the adapter connector; and
the plug connector comprises a connection interface, the connection interface comprising a plurality of ridges, the plurality of ridges configured to facilitate engagement between the plug connector and the first fluid flow device.

63. The kit of claim 61, wherein:
the first portion further comprises:
a base comprising a base port coupled to the plug connector, the base port configured to facilitate movement of a fluid through the oral care coupling, and
an adapter connector;
the first portion further comprises a first lumen, the first lumen in fluid communication with the base port to facilitate movement of the fluid within the first portion; and
the first lumen is configured to route the fluid through the first portion to the second portion.
